(19) United States
(12) Patent Application Publication
(10) Pub. No.: US 2015/0134556 A1
(43) Pub. Date: May 14, 2015

(54) SYSTEMS AND METHODS FOR RAISING DONATIONS

(71) Applicant: RevUp Software Inc., Redwood City, CA (US)

(72) Inventors: Steven J. Spinner, Menlo Park, CA (US); Aman Naimat, San Francisco, CA (US); Aaron Redalen, Burlingame, CA (US)

(21) Appl. No.: 14/530,336

(22) Filed: Oct. 31, 2014

Related U.S. Application Data
(60) Provisional application No. 61/903,321, filed on Nov. 12, 2013.

(51) Int. Cl. G06Q 30/02

(52) U.S. Cl. CPC G06Q 30/0279
USPC 705/329

(57) ABSTRACT

The present disclosure provides methods for raising donations by collecting and reviewing content from various information sources based on a set of criteria. The information sources can include user network information and third party information. The criteria can include keywords, parameters, or a combination thereof. The results can be used to prioritize prospects. The results can be used to customize communication with the prospects. In some cases, results based on multiple criteria can be overlaid.

### CROSS-REFERENCE

This application claims the benefit of U.S. Provisional Application No. 61/903,321, filed Nov. 12, 2013, which is incorporated by reference herein in its entirety.

### BACKGROUND

Fundraising is a significant way for organizations to obtain money and resources for their operations. Fundraising is carried out by a broad array of organizations including, for example, public interest groups, political groups, campaigns or committees, research organizations, educational institutions, religious groups, philanthropic groups, public broadcasters, environmental interest groups, etc. Fundraising can be carried out by individual fundraisers on behalf of an organization.

### SUMMARY OF THE INVENTION

The disclosure provides systems and methods for raising donations. In some examples, systems and methods of the disclosure can be used for managing fundraising events.

In some embodiments, the disclosure provides a method for raising donations, the method comprising: (a) receiving, from a user, a request for raising a donation for a cause; (b) identifying a prospect based on said request; (c) identifying a keyword associated with said cause; d) collecting user network information associated with said prospect from a user network provider; (e) collecting third party information associated with said prospect from a third party provider; (f) determining by a processor of a computer system a relative likelihood of said prospect making a donation to said cause in comparison to another prospect based on said user network information, said third party information, and said keyword associated with said cause; and (g) outputting said relative likelihood of said prospect making a donation to said cause in comparison to said other prospect. In some embodiments, said prospect is associated with said user. In some embodiments, said user network information is associated with said keyword. In some embodiments, said third party information is associated with said keyword. In some embodiments, said determining said relative likelihood of said prospect making a donation to said cause in comparison to said other prospect comprises weighting said user network information and said third party information with a probabilistic model. In some embodiments, determining said relative likelihood of said prospect making a donation to said cause in comparison to said other prospect comprises correlating said user network information and said third party information. In some embodiments; outputting said relative likelihood of said prospect making a donation to said cause in comparison to said other prospect comprises ranking said prospect against a population of other prospects. Some embodiments further comprise scoring said prospect based on said relative likelihood of said prospect making a donation to said cause in comparison to said other prospect. Some embodiments further comprise generating by said computer system a customized electronic message for said prospect based on said outputting. In some embodiments, said customized electronic message is based on a template from said user. Some embodiments further comprise generating an additional keyword based on said keyword associated with said cause. Some embodiments, further comprising generating an additional keyword based on said keyword associated with said cause by accessing user network information associated with said prospect, identifying a topic associated with said prospect, and creating said additional keyword based on said topic. In some embodiments, determining said relative likelihood of said prospect making a donation to said cause in comparison to said other prospect comprises weighting said keyword associated with said cause by a keyword attribute. In some embodiments, said cause is political. In some embodiments, said cause is non-profit. In some embodiments, said cause is academic.

In some embodiments, the disclosure provides a computer program product comprising a computer-readable medium having computer-executable code encoded therein, said computer-executable code adapted to be executed to implement a method for raising donations, said method comprising: a) providing a system, said system comprising: i) a user input module; ii) a prospect module; iii) a keyword module; iv) an information module; v) a comparison module; and vi) an output module; b) receiving by said user input module a request for raising a donation for a cause; c) identifying by said prospect module a prospect based on said request; d) determining by said keyword module a keyword associated with said cause; e) obtaining by said information module user network information associated with said prospect from a user network provider; f) obtaining by said information module third party information associated with said prospect from a third party provider; g) determining by said comparison module a relative likelihood of said prospect making a donation to said cause in comparison to another prospect based on said user network information, said third party information, and said keyword associated with said cause; and h) outputting by said output module said relative likelihood of said prospect making a donation to said cause in comparison to said other prospect. In some embodiments, said system further comprises a prospect database, wherein said identifying by said prospect module a prospect based on said request comprises searching said prospect database by said prospect module based on said request, thereby identifying said prospect. In some embodiments, said system further comprises a ranking module, wherein said method for raising donations further comprises ranking by said ranking module said prospect against a population of other prospects based on said relative likelihood of said prospect making a donation to said cause. In some embodiments, said system further comprises a scoring module, wherein said method for raising donations further comprises scoring by said scoring module said prospect based on said relative likelihood of said prospect making a donation to said cause.

In some cases, the disclosure provides a computer-implemented method for raising donations, comprising: (a) receiving, from a user, a request for raising donations for a cause having an attribute; (b) collecting prospects; (c) providing a keyword associated with said cause; (d) collecting user network information associated with at least one of said prospects from a user network provider, and storing at least a portion of said user network information or information derived therefrom in a computer memory; (e) collecting third party information associated with at least one of said prospects from a third party provider, and storing at least a portion of said third party information or information derived therefrom in a computer memory; and (f) with the aid of a computer processor, generating a list of prioritized prospects using (i) said user network information and said keyword, or (ii) said third party information and said keyword.

In other cases, the disclosure provides a computer readable medium comprising machine-executable code that, upon execution by a computer processor, implements a method, the method comprising: (a) receiving, from a user, a request for raising donations for a cause having an attribute; (b) collecting prospects; (c) providing a keyword associated with said cause; (d) collecting user network information associated with at least one of said prospects from a user network provider, and storing at least a portion of said user network information or information derived therefrom in a computer memory; (e) collecting third party information associated with at least one of said prospects from a third party provider, and storing at least a portion of said third party information or information derived therefrom in a computer memory; and (f) with the aid of a computer processor, generating a list of prioritized prospects using (i) said user network information and said keyword, or (ii) said third party information and said keyword.

The disclosure provides a computer-implemented method for raising donations that is configured to, for example, identify, extract, stratify, and rank data. In some cases prospects are associated with users. Some cases further comprise automatically collecting, with the aid of a computer processor, said prospects from contacts associated with said user stored in a computer memory. In other cases, said user network information collected in (d) or information derived therefrom is related to said keyword. In some embodiments said third party information collected in (e) or information derived therefrom is related to said keyword. Some embodiments further comprise weighting said user network information collected in (d) and said third party information collected in (e) using a probabilistic model executed by a computer processor. In other embodiments step (f) further comprises generating said list of prioritized prospects using (i) and (ii). In another embodiment step (f) further comprises generating said list of prioritized prospects using a parameter associated with a type of said cause. Some embodiments further comprise correlating, with the aid of a computer processor, (i) and (ii) to generate said list of prioritized prospects. Other embodiments further comprise correlating (i) and (ii) using a probabilistic model executed by a computer processor. Some embodiments further comprise rank-ordering said prioritized prospects. Other embodiments further comprise contacting a subset of said prioritized prospects. Other embodiments further comprise customizing electronic messages to said subset of said prioritized prospects based on said user network information collected in (d), said third party information collected in (e), said keyword, said parameter, said attribute, said type, or a combination thereof. Another embodiment further comprises customizing electronic messages to said subset of said prioritized prospects based on a template from said user.

In some cases, the disclosure provides a computer-implemented method for raising donations that is configured to identify, extract, stratify, and rank data. In some cases, step (c) further comprises generating, with the aid of a computer processor, said keywords. In other cases, step (c) further comprises receiving said keyword from said user. In some embodiments, said keyword is a default keyword associated with said user. In other embodiments, step (f) further comprises weighting said keyword by a keyword attribute. In another embodiment, said type is political giving, non-profit giving or academic giving. In some cases, said keyword is related to said attribute. Other cases further comprise accessing user network information associated with a prospect, and identifying, with the aid of a computer processor, a topic associated with said prospect. Another case further comprises storing said topic in a computer memory. Another case further comprises using said topic as keyword. Some embodiments further comprise raising donations by organizing a fundraising event. Other embodiments further comprise outputting said list of prioritized prospects. Another embodiment further comprises outputting said list of prioritized prospects on a user interface. In some cases, each of said prospects is capable of, or is suspected of being capable of, providing a donation. Other cases further comprise presenting at least a portion of said user network information to said user. Another case further comprises allowing said user to revise said list of prioritized prospects.

In some cases, the disclosure provides a system for raising donations, comprising: (a) a communications interface operatively coupled to a user terminal, a user network provider, and a third party provider; and (b) a computer processor coupled to said communications interface, wherein said computer processor is programmed to execute machine executable code implementing a method, the method comprising: (i) receiving, from said communications interface, a request from a user for raising donations for a cause having an attribute; (ii) collecting, with the aid of said computer processor, prospects; (iii) providing, with the aid of said computer processor and/or said communications interface, a keyword associated with said cause; (iv) collecting, from said communications interface, user network information associated with at least one of said prospects from said user network provider, and storing at least a portion of said user network information or information derived therefrom in a computer memory; (v) collecting, from said communications interface, third party information associated with at least one of said prospects from said third party provider, and storing at least a portion of said third party information or information derived therefrom in a computer memory; and (vi) with the aid of a computer processor, generating a list of prioritized prospects using (i) said user network information and said keyword, or (ii) said third party information and said keyword. In some cases, the disclosure provides a system that is configured to identify, extract, stratify, and rank data. The system can be used by any entity, including private and publically owned entities. For instance an entity can be a corporation, a cooperative, a partnership, a sole trader, or a limited liability company. A system of the disclosure can be used by a for-profit or a non-profit organization.

In some embodiments a system of the disclosure that is configured to implement step (vi) further comprises generating said list of prioritized prospects using (i) and (ii). In other embodiments a system of the disclosure that is configured to implement step (vi) further comprises generating said list of prioritized prospects using a parameter associated with a type of said cause. In some cases, a system of the disclosure is further configured to correlate, with the aid of a computer processor, (i) and (ii) to generate said list of prioritized prospects. In some cases said method is implemented over a network. In other cases said method is implemented in accordance with a setting. In yet other cases, said setting is a data driven setting, a self-modifying setting based on data usage, a default setting, or a runtime user setting. In some embodiments said donations are political donations, non-profit donations, academic donations, or a combination thereof. In other embodiments said user is an individual and/or an organization. In other embodiments said computer memory is located within said system, in a remote location in communication with said system, or at said user terminal. In some cases said third party information comprises public information, private information, or a combination thereof. In other cases said method further comprises automatically selecting a subset of said prioritized prospects. In other cases said prospects are associated with said user.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

FIG. 1 shows a conceptual schematic of entities and processes involved in fundraising.

FIG. 2 shows a method for raising donations.

FIG. 3 shows a system for implementing methods of the disclosure.

FIG. 4 is a block diagram illustrating a first example architecture of a computer system that can be used in connection with example embodiments of the present invention.

FIG. 5 is a diagram illustrating a computer network that can be used in connection with example embodiments of the present invention.

FIG. 6 is a block diagram illustrating a second example architecture of a computer system that can be used in connection with example embodiments of the present invention.

FIG. 7 illustrates a global network that can transmit a product of the invention.

FIG. 8 illustrates a representative interface of a system and computer program product of the invention.

FIG. 9 illustrates a representative full window representation of a ranking of prospective donors provided by the system and computer-program products of the invention.

FIG. 10 illustrates representative third party information that can be transformed by a system of the invention to provide a stratified ranking of prospective donors.

FIG. 11 illustrates representative parameters that can form a database of third party information associated with at least one of said prospects.

### DETAILED DESCRIPTION

The term “user,” as used herein, generally refers to a fundraising entity, such as, for example, organizations or individual fundraisers (e.g., supporters of an organization). The users may be independent entities, dependent entities, or both. For example, a user hierarchy can exist in which an independent user entity (e.g., an organization) can provide seats (e.g., 1 seat, 5-10 seats, or at least about 1, 2, 3, 4, 5, 6, 7, 8, 10, 15, 20, 25, 50, 75, 100, 150, 200, 250, 500, 1,000, 2,000 or more seats) to a software platform implemented in accordance with the present disclosure to one or more other users or dependent entities (e.g., supporters of the organization, supporters of a given cause). In some cases, the seats may be provided from a provider of the software platform to the independent user entity for a fee. In some cases, an independent user entity (e.g., an organization) may be provided with an unlimited number of seats by the provider of the software platform in exchange for a given (e.g., negotiated) share of funds raised (e.g., at least about 0.1%, 0.5% or 1% of funds raised by the independent user entity, or by one or more individual users or dependent entities associated with the independent user entity, over less than or equal to about 1 year, 2 years, 3 years, 4 years or 5 years) during the independent user entity's (e.g., the organization's) term of use of the software platform.

Fundraising can be carried out by various fundraising entities. Fundraising can be carried out by a variety of organizations and/or their associated users. In one example, fundraising can be carried out by political organizations, such as political groups, campaigns or committees. In some cases, donations can be raised through political fundraising events. For example, individuals may be invited to fundraising events (e.g., through electronic mail (email) invitations, mailed invitations, text message invitations, telephonic invitations, invitations in person, or invitations in a meeting). In some cases, donations can be raised through direct requests for donations (e.g., via email, mail, text message, phone call, in person, in a meeting). In some cases, fundraising may involve broadening a contact structure of the fundraising entity in expectation of raising donations, or as a way to expand the fundraising entity's support base. In another example, fundraising can be carried out by non-profit organizations, such as charitable organizations, foundations, religious groups, philanthropic groups, museums, think tanks, public interest groups, public broadcasters, gun rights advocates, or environmental interest groups. In some cases, donations can be raised through fundraising events including, for example, fundraising events for a health-related charity (e.g., associated with a disease such as cancer or multiple sclerosis) involved in providing grants or raising awareness, a social cause, or a public media broadcasting outlet. In another example, fundraising can be carried out by academic organizations (which may or may not be non-profit organizations), such as research organizations or educational institutions. In a further example, fundraising can also be carried out by for-profit entities (e.g., a hospital) on behalf of a non-profit entity or to raise donations for a given cause.

The term “cause,” as used herein, generally refers to an objective or goal that a fundraising entity is attempting to achieve through its fundraising efforts. For example, a non-profit fundraising entity (e.g., Susan G. Komen® breast cancer charity) can organize a breast cancer walk to raise money for breast cancer. In such a case, the cause may be the support of breast cancer research, breast cancer awareness, walking in support of breast cancer, etc. The cause may have an “attribute,” such as, for example, “breast cancer,” “cancer,” “walk,” “research”, “awareness” or “health”. The cause may be of a given “type,” such as, for example, non-profit giving. Other examples of types of cause can include, but are not limited to political giving and academic giving.

The term “keyword,” as used herein, generally refers to a word (or set of words) that can be used to prioritize or customize fundraising efforts. Keywords may be used for searching or evaluating various information sources or providers (e.g., third party information, user network information). For example, when raising money for a breast cancer walk, the information sources can be searched using the keywords “runner,” “walker,” or “breast cancer.” In some cases, keywords can be related to or substantially similar to attributes. For example, “breast cancer” can be an attribute of a cause as well as a keyword. Keywords may also have “keyword attributes,” including, for example, frequency of occurrence of each keyword in an information source.

The term “parameter,” as used herein, generally refers to a metric (or set of metrics) that can be used to prioritize or customize fundraising efforts. Parameters may be used for searching or evaluating various information sources or providers (e.g., third party information, user network information). Parameters can be associated with a type of cause. For example, when raising donations for an event associated with a political cause (e.g., a fundraising event for a political candidate), the information sources can be processed using parameters such as previously donated funds, party previously donated to, geographic proximity to the event, issues alignment with the candidate, etc. In some cases, default parameters can be associated with each type of cause.

The term “user network information,” as used herein, generally refers to information available in social media (e.g., Facebook® or LinkedIn® activity such as posts, comments, likes, event attendance, association with other users), email clients or archives (e.g., how many times were emails exchanged with a given contact), personal organizers comprising personal or business contacts (e.g., frequent contacts), calendars, data feeds, or other information sources associated with a user. In some cases, user network information may include any information accessible or searchable over a network such as, for example, the Internet. In some cases, the user network information can be publicly accessible or public. In some cases, the user network information can be private and may require authentication for access.

The term “social media,” as used herein, generally refers to web-based and/or mobile technologies which may or may not be associated with social networks, including, for example, weblogs, homepages, social media aggregators, private portions of social networks, and public portions of social networks. Social media may include privately communicated information or data, publicly communicated information or data, or a combination thereof.

The term “user network provider,” as used herein, generally refers to an entity that provides (e.g., maintains, serves) user network information, such as, for example, social media providers, weblog publishers, or email providers.

The term “third party information,” as used herein, generally refers to personal, financial, demographic, and biographical information. Such information may include, for example, name, age, income, compensation data, marital and family status, address, giving history (e.g., non-profit affiliations and contributions, federal (e.g., federal elections contributions (FEC)), state, regional and/or local contributor and contribution records as submitted by various political and/or government organizations (e.g., accessible in accordance with appropriate legal constraints, such as federal, state, regional and/or local legal constraints), government election compliance records memberships and data on the membership organization, political interests and associations, individual and household demographic and financial data (e.g., aggregate credit data, credit report data, census data), work history, board membership, executive positions held, personal biography, stock holdings and sales, real estate assets, luxury item ownership, median income and median home value based on zip code, voter data, criminal background history, geography, demography, and/or other private or public information. The third party information may include public information (e.g., information that the public is expected or entitled to access), private information (e.g., data or analysis assembled by a private entity and not intended for general public use), or a combination thereof. In some cases, the third party information can be publicly accessible or public (e.g., open access). In some cases, the third party information can be private and may require authentication for access (e.g., restricted access).

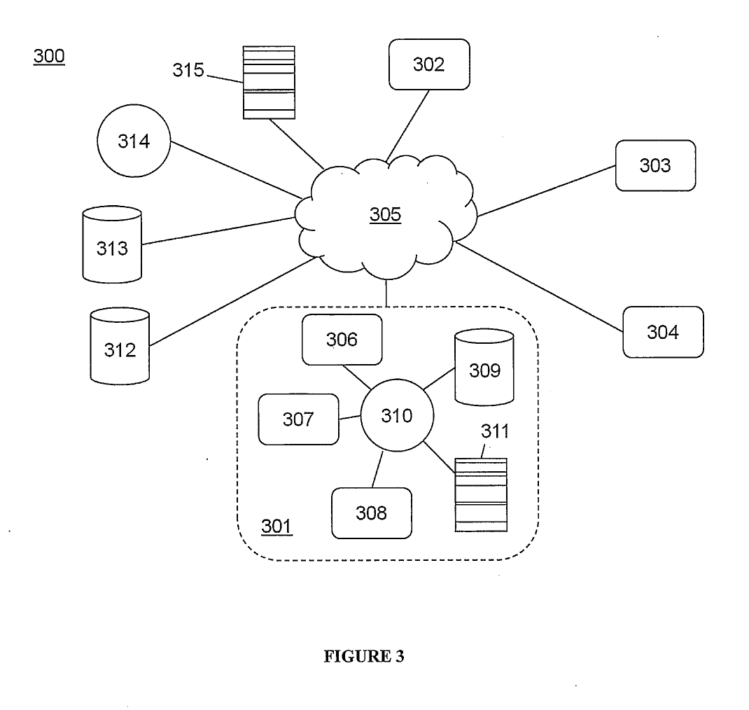

The term “third party provider,” as used herein, generally refers to an entity that provides (e.g., maintains, serves) third party information. In some examples, third party providers can include government record (e.g., federal, state, regional and/or local information) databases resident on sites, servers, or data repositories maintained by the government or by independent data providers on behalf of the government. In some cases, the information maintained in such databases may be subject to legal restrictions. Such information may or may not have the capability to be collected or imported into other systems (e.g., into a database on system 300 in FIG. 3). Third party providers may further include government election compliance authorities, privately maintained (e.g., maintained by non-governmental organizations) records of election information, official lists of voters, voter registration systems and their providers, privately maintained (e.g., maintained by non-governmental organizations such as non-profit or academic organizations) records of political contributions, records tracking the relationship between influential individuals and organizations in the private and public sector (e.g., board members involved in public and private companies, non-profit organization, private organization, public and private academic institutions, public service entities (e.g., federal advisory boards; department advisory boards; state, regional and local advisory boards), foundations, etc.), third party vendors who provide services to government entities, phone listings, subscriptions listings, purchase habits listings, home renovations listings, financial transaction listings, real property listings, marriage listings, divorce listings, criminal citation listings, offender listings, and death listings.

In some examples, the systems of the disclosure may comprise one or more subsystems providing third party information or be linked to one or more separate systems providing third party information (e.g., third party providers). Such third party provider system may include a user platform. In some cases, the third party information can be publicly accessible or publicized, provided in partnership, provided privately, proprietary, provided (e.g., publicly, privately, or to a set of given entities) upon release (e.g., release by the user of the third party user platform), provided according to other data sharing preferences, or any combination thereof. In some cases, the third party information can be released to given public or private entities (e.g., system 300 in FIG. 3).

In some examples, users (e.g., organizations) may be third party providers. For example, organizations (e.g., non-profit organizations, academic institutions) can maintain personal and transactional information relating to contacts such as, for example, prospects, donors, volunteers, board members, associates, and event participants. Such information may include, for example, memberships or subscriptions, past patients, alumni, parents of alumni, students, past donations (e.g., a book with donors), involvement with the organization, mailing lists, or lists of people affiliated with or with some other relationship or interest in the organization, as well as age, gender, relationship to the organization, major and degree or other information relating to such individuals. In some cases, such information can be publicly accessible or publicized, provided in partnership (e.g., a non-profit or other client organization may provide (with permission) access to at least a portion of its data to the system, and may, in return negotiate a discount for using the system), provided privately, proprietary, provided according to other data sharing preferences, or any combination thereof. In some cases, such information can be correlated with likelihood to give. For example, a regular donor to a university may also be an alumnus, parent of a current student, volunteer coordinator, or a community spokesman. In some cases, the system may provide such users (e.g., organizations) with updated data on their contacts. For example, a university that is using the software for fundraising within its alumni network may also obtain updated contact information for other purposes (e.g., for use in other fundraising communications). Further, in some cases, the system may provide (e.g., upon release of such information by a user) data to a non-user organization (e.g., a non-user university), thereby acting as a third party provider that provides information (e.g., for a fee) to aid the non-user organization in updating data on its contacts.

The term “prospect,” as used herein, generally refers to a contact associated with a user (e.g., a person that directly or indirectly knows or is in contact with the user) that is capable of, or suspected of being capable of, providing a donation (e.g., becoming a donor). Contacts associated with a user may become prospects associated with the user. The user's contacts may include, for example, personal or business contacts maintained by various sources, including email clients (e.g., Microsoft® Outlook), email lists, membership lists or records, in social media (e.g., Facebook® or LinkedIn® relationships), or phone or cell phone directories. In some cases, the contacts can be scraped, harvested, extracted or collected (e.g., automatically, semi-automatically, manually) from these sources. In some cases, the contacts associated with individual users can be automatically obtained from user network information. The contacts associated with the user can be stored in a computer memory (e.g., in a computer memory on a system of the user, in a computer memory on a system of a network information provider).

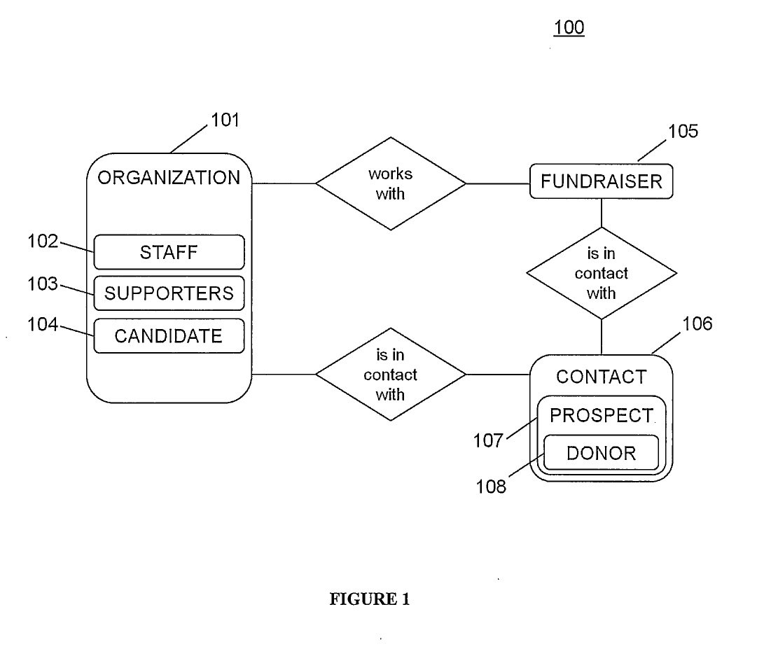

FIG. 1 shows a conceptual schematic of entities and processes involved in fundraising. Fundraising may involve a contact structure 100. Fundraising may be performed by a fundraising entity, such as an organization 101 or an individual (also “fundraiser” herein) 105. In some examples, the organization 101 can be a political group, campaign or committee (e.g., national, regional or local groups and/or organizations associated with Democratic Party or Republican Party, Libertarian Party, Green Party, or committees like the Democratic National Committee (DNC), Republican National Committee (RNC), Democratic Senatorial Campaign Committee (DSCC), National Republican Senatorial Committee (NRSC), Democratic Congressional Campaign Committee (DCCC), National Republican Congressional Committee (NRCC), Democratic Governors Association (DGA), Republican Governors Association (RGA)). In some examples, the organization 101 can be a non-profit organization including, but not limited to a charitable organization, a foundation, a religious group, a philanthropic group, a museum, a think tank, a public interest group, a public broadcaster or an environmental interest group (e.g., The Leukemia & Lymphoma Society, Susan G. Komen® breast cancer charity, The Heritage Foundation, The Brookings Institution, Cato Institute, Center for American Progress, Hoover Institution, National Public Radio (NPR), League of Conservation Voters, Sierra Club). In some examples, the organization 101 can be an academic organization (e.g., a private university, prep school, public school community foundation, a community college, a research institution). In some examples, the organization 101 can be a combination of political, non-profit and/or academic organizations (e.g., a political organization can be a non-profit or a university student club). In some examples, the organization 101 can be a for-profit organization (e.g., a hospital, a business). In some examples, the organization 101 can be a combination of for-profit and non-profit entities. For example, the organization 101 may be a company or business, such as, for example, a technology company, a service industry, a manufacturer, or any other type of company or business. A for profit entity can be, for instance, a cooperation, a cooperative, a partnership, a sole trader, or a limited liability company. Businesses may have customers. In some instances, the systems and methods herein can be used to allow the organization (e.g., business) 101 to identify additional customers (prospects) by leveraging the contacts (e.g., friends, business partners, customers or suppliers of the business) 106 of existing customers 105. In one example, for instance, a for-profit entity can be an organization that sells solar panels and is interested in identifying customers who might be interested in buying solar panels.

In some cases, the fundraiser 105 can be associated with the organization 101. In other cases, the fundraiser 105 may be raising donations independently from the organization 101. In an example, the fundraiser 105 may not be affiliated with any organization. In another example, the fundraiser 105 can raise donations for personal purposes (e.g., a personal project or endeavor).

The fundraising entities 101 and/or 105 may be users. In some situations, the fundraiser 105 can be an independent user. For example, the fundraiser may not be affiliated with the organization 101, or the fundraiser may be affiliated with the organization 101 but have an independent user account. Alternatively, the fundraiser 101 may be a dependent user. For example, the organization 101 can provide user seats to one or more dependent users 105. In some situations, any user (e.g., the users 101 or 105) may maintain multiple seats to a fundraising system (see, e.g., FIG. 3), and may provide the user seats to other users, thereby creating a multi-level hierarchy of users (e.g., independent user providing seats to a plurality of dependent users, who in turn provide seats or other access privileges to one or more other dependent users). In some implementations, dependent user seats may be configurable by the independent user, or by the independent or dependent user that provides the seats, as described, for example, in relation to various configurations and user settings elsewhere herein.

The organization 101 may include various individuals associated with the organization. For example, the organization may include staff 102 (e.g., program managers, campaign managers, finance staff, development directors, board members), supporters 103, and/or other entities or individuals. In some cases (e.g., in the case of a political organization), the organization may include a candidate (or candidates) 104. The organization may be associated with a cause. In some cases, the cause can be associated with the candidate 104 (e.g., a political campaign on behalf of the candidate). Further, the organization 101 can be associated with various other organizations, institutions, or other entities. Such entities may be formally affiliated with the organization 101. In such cases, the entities may freely exchange services or information with the organization 101. In some cases, such entities may have a limited affiliation to the organization 101, in which case exchange of services and information may be restricted or limited. The supporters 103 can include, for example, individuals that have an interest in issues or causes promoted by the organization (e.g., event participants, volunteers), voters (e.g., in the case of a political organization), fundraisers, and donors. At least a portion of the supporters 103 may be future donors (e.g., prospects).

In some implementations, the fundraisers 105 can be one or more of the supporters 103. In other implementations, the fundraisers 105 can include inside fundraisers (e.g., the staff 102). In some cases, the fundraiser 105 can be the candidate 104. In some implementations, the fundraisers 105 can be independents not affiliated with the organization 101. In some situations, the fundraisers 105 can be volunteers. In other situations, the fundraisers 105 can be paid (e.g., directly by the organization 101 or by an intermediary organization or entity).

The fundraising entities (e.g., the entities 101, 105) can be directly or indirectly connected to a plurality of individuals 106 (also “contacts” herein). In one example, the fundraiser 105 can work with the organization 101. The fundraiser 105 can be, for example, a supporter of the organization, or an inside fundraiser such as a staff member. The fundraiser 105 can also be unaffiliated with the organization 101. The fundraiser 105 can have a contact network including a plurality of contacts 106. The fundraiser 105 may be directly in contact with the contacts 106 (e.g., the fundraiser may “know” the contact). The contacts 106 may include prospects 107 (e.g., present or future supporters). At least a portion of the prospects may include donors 108 (e.g., present or future donor supporters). In this configuration, the fundraiser (also “user” herein) 105 can collect the prospects 107 from his/her contacts 106 (e.g., the fundraiser 105 can be an individual tapping his/her own contact network) using, for example, the methods and systems of the disclosure. In some configurations, the fundraiser 105 may be indirectly in contact with at least a portion of the contacts 106. For example, the contacts can include contacts of contacts (e.g., secondary contacts). Secondary contacts may be collected in a similar fashion as primary contacts.

In another example, the organization 101 can be the fundraising entity. The organization 101 can have a contact network including a plurality of contacts 106. In some cases, the organization 101 can be directly in contact with a portion of the contacts 106 (e.g., via email communication with a past donor, mailing lists, memberships or subscriptions). For example, the organization (e.g., DNC) can have emails from a contact (e.g., past donor “John Doe”). The organization may not be otherwise linked or connected to the contact. In some cases, the organization 101 can be indirectly in contact with a portion of the contacts 106. For example, the organization 101 can incorporate the contact networks of the various individuals associated with the organization (e.g., supporters, candidate, or staff) into its contact network 106. In this configuration, the organization (also “user” herein) 101 can collect the prospects 107 from its contacts 106 using, for example, the methods and systems of the disclosure. The organization 101 may be directly or indirectly in contact with the various individuals associated with the organization (e.g., the contacts 106 can include the various individuals associated with the organization). The contacts 106 may again include prospects 107, and at least a portion of the prospects may include donors 108.

The disclosure provides systems and methods for raising donations. In some examples, systems and methods of the disclosure can be used for managing fundraising events. Fundraising events can be organized by fundraising entities such as, for example, organizations or individual fundraisers (e.g., supporters of an organization). Raising donations (e.g., in conjunction with a fundraising event) may include providing a list of prospects (e.g., event invitees). The list of prospects may include contacts or connections of the fundraising entity. In some cases, the list of prospects can be indiscriminate. For example, email invitations can be sent to a substantial portion or all of a fundraising entity's contacts (e.g., invitations can be sent to about 2,000 personal contacts of an individual fundraiser). In some cases, the list of prospects can be limited. For example, the fundraising entity can reach out (e.g., through personalized emails or direct phone calls) to a limited subset of contacts. In some cases, individual emails can be sent to an extended list of prospects. For example, the fundraising entity can send personalized emails to an extended subset of its contacts (e.g., invitations can be sent to a subset, such as about 50, of the about 2,000 personal contacts of the individual fundraiser).

In some implementations, a need exists to generate a limited list of prospects that selectively includes prospects or invitees that are likely to contribute to or attend an event for a cause for which donations are sought by the fundraising entity. Accordingly, recognized herein is the need for systems and methods that permit fundraising entities to suitably obtain and prioritize prospects (e.g., by creating a prioritized list of invitees to a fundraising event). For example, prospects collected from contacts associated with a fundraising entity may be prioritized in accordance with determined belief in a cause or likelihood to show up to a fundraising event. Further recognized herein are various limitations associated with customizing communication (e.g., emails) when contacting selected prospects. In some cases, enhanced functionality for prioritization or customization herein may be achieved through the use of keywords associated with a given cause. In some cases, enhanced functionality for prioritization or customization herein may be achieved through the use of parameters associated with a type of a cause. Information from a variety of information sources, including but not limited to user network information and third party information, may be employed in conjunction with prioritization or customization as described herein.

An aspect of the disclosure relates to a computer-implemented method for raising donations. The method can include prioritizing prospects in accordance with a likelihood of giving a donation. The method can include prioritizing prospects in accordance with a likelihood of having an interest in a cause. In some implementations, the method can include prioritizing prospects in accordance with a likelihood of having an interest in a fundraising event or an associated cause. The prioritization can be based on a set of criteria. For instance, the criteria can include, but are not limited to political affiliation, financial situation, social and religious beliefs, moral principles, or interest in various causes. The criteria can be related to the cause. The criteria can include keywords or parameters. In some cases, multiple criteria can be used.

The method can further include collecting and reviewing content from various information sources based on the set of criteria. For example, the method can include searching or evaluating content from various information sources (e.g., user network information from user network providers, third party information from third party providers) using keywords, parameters, or a combination thereof. In some cases, the method can include using a search engine to search and/or evaluate content from the various information sources using keywords, parameters, or a combination thereof. In some cases, results based on multiple criteria can be overlaid. The method can include using a variety of algorithms to collect and review the content from the various information sources. Further, the method can include generating a list of prioritized prospects based on the results obtained through the searching or evaluation.

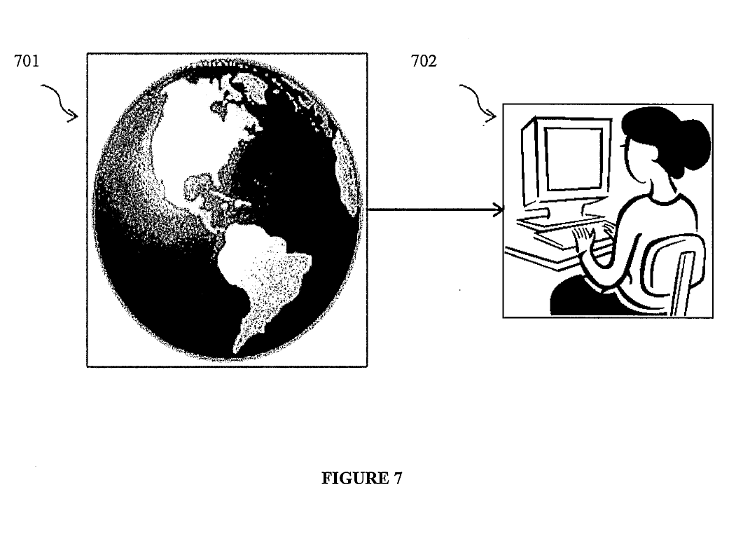

In some implementations, the method may include selective sharing or disclosure of information from individuals to fundraising organizations. For example, a dashboard (see, for example, FIG. 7) visible by organization staff (e.g., the staff 102 of the organization 101) may include the names of prospects selected by an individual fundraiser as likely to contribute. Other prospect details (e.g., addresses, phone numbers) may only be visible to the individual (e.g., individual fundraiser) whose contacts these prospects are, and not to the fundraising organization. Thus, the dashboard may be seen by an individual fundraiser, and with the individual fundraiser's permission, also by the organization with which the fundraiser works.

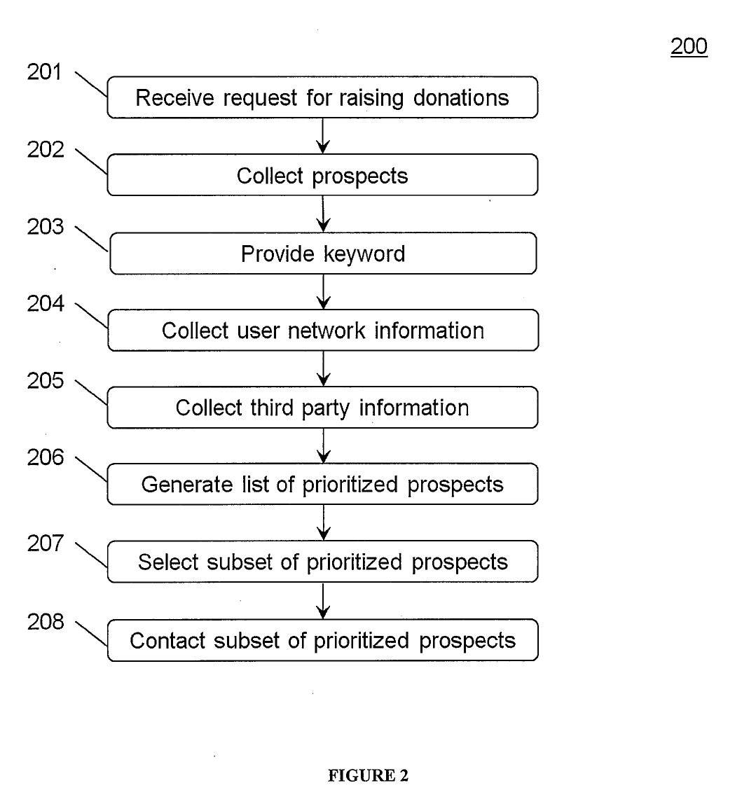

FIG. 2 shows a method 200 for raising donations. The method can be implemented by a computer system (see, e.g., FIG. 3) for accessing various information sources, and searching or evaluating information provided by the information sources based on criteria such as keywords or parameters. The computer system can be configured to provide prioritization or customization of fundraising efforts in accordance with the results of the information searched or evaluated. The steps of the method may or may not be performed in the order shown or described. In some cases, one or More steps may be optional and/or substituted by other steps. In some situations, individual steps may be broken up into several steps.

With reference to FIG. 2, in a first step 201, the system can receive a request for raising donations. The request can be provided by a user. The request can specify a cause having an attribute. As described in greater detail elsewhere herein, the user can be, for example, an organization or an individual. Further, the user can be an independent user or a dependent user. In some cases, the request can be provided in accordance with user hierarchy. For example, users that are given seats to the system by another user may automatically inherit the request. In such cases, the user may be limited to the inherited request, may have the ability to edit the request, or may be able to override the inherited request or to provide a new request. In some situations, multiple requests from each user may be accommodated by the system. In some cases, the request can be provided once and saved by the system for future access. In other cases, the request can be saved until otherwise prompted by the user. In yet other cases, the request may need to be provided each time the system is accessed. The user may need to provide login or authentication information to the system before the request can be received by the system. In some situations, providing the login or authentication information can give the system access to user-related information (e.g., user contacts, user network authentication information, or settings). For example, such information may be stored in a computer memory and made accessible upon user login.

Next, in a second step 202, the system can collect or identify prospects. Prospects may be collected from contacts associated with the user (e.g., individuals that the user is in email contact with, individuals in the user's contact list, individuals on the user's calendar). For example, prospects can be collected in accordance with the contact structure 100 in FIG. 1. In some cases, the contact structure 100 may be limited by legal considerations (e.g., depending on jurisdiction). For example, some organizations (users) may have a limited contact structure in accordance with state or federal law. Such limitations may be provided to the system by the user (e.g., by answering questions during login or registration), or may be determined by the system (e.g., automatic check of registration records for organizations performed by the system during login or registration). Further, such limitations may be incorporated and saved in memory as user-related information (e.g., as default user settings). The contacts may be stored in a computer memory on the user's system or remotely from the user's system. In some cases, the contacts can be accessed, and extracted, harvested or collected (e.g., scraped) (e.g., automatically, semi-automatically, manually) from various sources. For example, the system can automatically collect the prospects by extracting or harvesting (e.g., scraping) the user's contacts.

A third step 203 can include providing a keyword associated with the cause. In some cases, the keyword can be related to the attribute of the cause. In an example, a user may wish to raise donations for a democratic cause (e.g., a democratic proposal for immigration reform) in which technology or business leaders may take a strong interest. Using the methods 200, the system may prioritize the user's contacts based on the keywords “technology” and “democrat.” In another example, when organizing a fundraising event for breast cancer, “breast cancer” can be used as a keyword. Further, if the fundraising event is a breast cancer walk, “runner,” “walker,” and “breast cancer” may be used as keywords.

In some cases, the keyword (or keywords) can be provided automatically. For example, upon repeated access by the same user, a previously used keyword can automatically be used. In another example, the keyword can be a default keyword. In some implementations, default keywords may be provided as user settings, described in greater detail elsewhere herein. In some cases, the default keyword can be determined at the time the user is provided with access to the system. For example, as described elsewhere herein, user hierarchies may exist. In such cases, the user may be given a seat that is preconfigured with a default keyword by another user.

In another example, user “John Doe” is associated with an organization (e.g., as volunteer or paid staff), such as political campaign “John Smith for Congress,” and is interested in raising donations for the political campaign. In some cases, the political campaign may give John Doe a seat on a fundraising system or platform (e.g., the system in FIG. 3) that is preconfigured with a default keyword, such as “John Smith.” Alternatively, the campaign may give John Doe a seat without the default keyword. In some cases, John Doe may obtain independent user access to the system. For example, John Doe may himself choose to use “John Smith” as a keyword. The user may also have the ability to select whether a keyword is to be used as a default keyword. The user can also choose a different keyword or additional keywords. Furthermore, John Doe can select “John Smith” to be a default keyword. The keyword may be retained by the system as a default associated with the user. In some implementations, users having independent user access (also “independent users” herein) may have the option of linking or importing keywords or user settings from other users. In some examples of such connections with other users, the user account may be transformed into a seat, and the user may become a dependent user. In other cases, the user account may remain independent and import only certain functionality or settings from other users (e.g., independent users or other dependent users).

Multiple keywords may be used. For example, follow-on keywords may be provided in addition to the default keyword. When no default keyword is provided, the user may input or select his/her own keywords. Additionally, the user may choose to repeat the steps of the method 200 iteratively, refining or adding keywords in each iteration.

In some cases, keywords may be input by the user (e.g., through a user interface). For example, the system can receive the keyword from the user. In some cases, the keyword can be generated by the system. For example, the keyword can be suggested or automatically generated by the system. In some instances, keywords generated by the system may be automatically applied. In other instances, user approval may be required.

In some examples, keywords can be used to prioritize prospects. In some examples, keywords can be used to customize communication with prospects. In some cases, different keywords may be used for prioritization and customization. For instance, different user settings or input can apply to prioritization and customization. For example, the user may be more involved in selecting or providing keywords for customization than for prioritization.

In a fourth step 204, the system collects or downloads user network information by accessing various user network providers. In some cases, the system can aggregate the user network information. In some cases, the system can collect only information derived from the information provided by the user network providers. In some cases, the system can collect a combination of the information provided by the user network providers and information derived therefrom. In some cases, the user may elect which user network providers to access, or conversely, which user network providers to leave out.

In some implementations, the user network information collected or information derived therefrom can be related to the keyword provided in step 203. In an example, the system can selectively collect or extract (e.g., scrape) information directly related to a given keyword (e.g., John Smith), such as occurrences of comments or posts that include the keyword. In another example, the system can selectively collect or extract (e.g., scrape) information indirectly or loosely related to the keyword. The system may determine that the keyword falls into a given category (e.g., category also comprising keywords “Democratic Party”, “Democrat,” “candidate,” “campaign”), and may selectively collect or extract (e.g., scrape) information related to the keywords in the same category. In some implementations, the user network information collected or information derived therefrom can be related to the attribute of the cause for which a request was received in step 201 (e.g., John Smith). In some cases, the attribute may include an issue that the cause promotes (e.g., immigration reform). In such examples, the system may search and retrieve content that can help the user ascertain the contact's viewpoints or interest in the issue. The user network information collected or information derived therefrom may also be related to a type of the cause for which a request was received in step 201 (e.g., political giving). The system may then search and retrieve content relating to political issues.

The user network information can be associated with the prospects identified in step 202. For example, the user network information can be collected by extracting or harvesting (e.g., scraping) information from various user network providers. Such information may include, for example, how many times did the user send an email to a contact, what individuals are on the user's frequent contacts list, what topics or issues were discussed in the user's emails with various contacts, what are the user's contacts posting in the user's social media, what information appears in the user's data feeds from various contacts, what appears in the user's contacts' social media or data feeds.

The method may include storing (e.g., during processing, temporarily storing, permanently storing) at least a portion of the user network information or information derived therefrom in a computer memory. In some cases, data may be manipulated, formatted or processed before being stored.

In some implementations, the method 200 may further include accessing user network information associated with a prospect, and identifying a topic associated with the prospect. For example, the method can include identifying topics that are important to the prospect. The topics may be automatically extracted. For example, the system can include a search engine configured for information retrieval and text mining using a weighting factor. The weighting factor may be a numerical statistic (e.g., term frequency—inverse document frequency) which reflects how important a word (e.g., topic) is to a body of information (e.g., social media page, weblog). The method may further comprise storing the topic in a computer memory. In some cases, the topic can be used as a keyword. For example, topics identified among prospects that became donors may serve as useful keywords for prioritizing other prospects.

The method may further include, in a fifth step 205, collecting or downloading third party information by accessing various third party providers. In some cases, the system can aggregate the third party information. In some cases, the system can collect only information derived from the information provided by the third party providers. In some cases, the system can collect a combination of the information provided by the third party providers and information derived therefrom. In some cases, the user may elect which third party providers to access, or conversely, which third party providers to leave out.

The third party information can be associated with the prospects identified in step 202. For example, the third party information can be collected by accessing information from various third party providers. Such information may include, for example, FEC database information, credit history, voter registration records, or email lists, memberships and subscriptions from various organizations.

As described in greater detail elsewhere herein, different third party providers may provide different data extraction and manipulation capabilities. In some cases, any description relating to collecting (e.g., searching, downloading, retrieving) user network information may equally apply to collecting third party information at least in some configurations. For example, the third party information collected or information derived therefrom can be related to the keyword provided in step 203, the attribute of the cause for which a request was received in step 201, the type of the cause for which a request was received in step 201, or a combination thereof. In some cases, the search engines described herein may be applied to collecting third party information directly from third party providers. In some cases, third party information may be retrieved by the system before being searched by the system. In some cases, the third party providers may provide search functionality.

The system 301 may include a search engine for enabling a user to search raw and aggregated content, such as user network information and third party information. The search engine can implement various search algorithms to facilitate the search. For example, the search engine can implement an incremental search algorithm, a heuristic search algorithm, or an incremental heuristic search algorithm to conduct the search.

The method may include storing (e.g., during processing, temporarily storing, permanently storing) at least a portion of the third party information or information derived therefrom in a computer memory. In some cases, data may be manipulated, formatted or processed before being stored.

In some implementations, the collection of user network information may be synergistically combined with the collection of third party information. For example, the information collected from various user network providers may identify additional third party providers or additional third party information that can be collected, and vice versa. In another example, the information collected from various user network providers may identify “buzz” (e.g., news, events, posts or trends related to prospects, keywords, parameters, attributes, types or any other criteria herein; general state, national or world news, events or trends) that can be used to alter the collection of user network information or third party information.

In a sixth step 206, the system generates a list of prioritized prospects. In some implementations, the list of prioritized prospects is generated using the user network information collected in step 204 and the keyword provided in step 203. In some implementations, the list of prioritized prospects is generated using the third party information collected in step 205 and the keyword provided in step 203. In some implementations, the list of prioritized prospects is generated using the user network information collected in step 204, the third party information collected in step 205 and the keyword provided in step 203. The method may include evaluating the user network information collected and/or the third party information collected using the keyword (or keywords).

In some examples, multiple keywords can be used. To generate the list of prioritized prospects, the method may include combining or weighting keywords (e.g., “technology” and “democrat”). In some examples, the system can utilize capabilities of search engines configured for information retrieval and text mining using a weighting factor (e.g., term frequency—inverse document frequency) to score and rank the relevance of a body of information given a user query (e.g., keywords). In some cases, the method includes weighting the keyword(s) by a keyword attribute. For example, the scoring/ranking can be driven by frequency of appearance. The system can evaluate user network information collected by the system for a given user. The user network information can include information about the user's contacts. A larger number of the contacts may mention or have a relationship to the keyword “technology” than to the keyword “breast cancer.” Thus, if a contact mentions or has a relationship to “breast cancer,” or to both “breast cancer” and “technology” (e.g., in his/her social media profile), the system may rank the contact higher than a contact that only mentions or has a relationship to “technology.”

In some implementations, the list of prioritized prospects is generated using the third party information (e.g., indicators of wealth) collected in step 205 and a parameter (e.g., a given prospect's capacity to give, issues alignment with a candidate) associated with the type of the cause (e.g., “political giving”) for which a request was received in step 201. The method may include evaluating the third party information collected using the parameter (or parameters).

Different types of the cause may be associated with different parameters. For example, “political giving” can be associated with a parameter expressing likelihood to give. Evaluation using such parameters may include analyzing (e.g., based on an algorithm) third party information including, for example, amount previously donated, party previously donated to, geographic proximity to an event, or political membership or affiliation. “Non-profit giving,” “academic giving,” or other types of cause may be associated with other parameters. Other parameters may include analyzing a different set of target data or information. Further, different types of causes may include varying degrees of complexity (e.g., complexity of algorithms). For example, academic giving may have a different complexity of evaluation than political giving. In some cases, the complexity of the evaluation process can be related to the complexity or constraints associated with a given contact structure (e.g., contact structure 100 in FIG. 1).

In some implementations, the list of prioritized prospects is generated using the user network information (e.g., how many times the user exchanged emails with a given contact) collected in step 204 and the parameter (e.g., a given prospect's capacity to give) associated with the type of the cause (e.g., “political giving”) for which a request was received in step 201. The method may include evaluating the user network information collected using the parameter (or parameters). The evaluation using the parameter may include criteria such as, for example, likelihood to give a donation. In one example, the user network information collected or derived by the system can include data regarding how many times the user exchanged emails with a given contact. Such information may be indicative of a closer relationship of the user with the given contact, and may therefore be used by the system to evaluate the contact as a prospect that is more likely to give than a contact that has less frequent correspondence with the user.

In some implementations, the method may include overlaying searches or prioritizations by keyword and by parameter. For example, the parameter(s) can be a first level of search or analysis, and the keyword(s) can be a second level of search or analysis for further refinement (e.g., for greater amplitude of search or prioritization algorithms). In some implementations, the method may include overlaying keyword searches/prioritizations of user network information and third party information. In some implementations, the method may include overlaying parameter searches/prioritizations of user network information and third party information. In some implementations, the user network information can be overlaid with the third party information prior to prioritization, during search or prioritization, following partial search or prioritization, or as a final step during search or prioritization. For example, the method may include weighting the user network information collected in step 204 and the third party information collected in step 205 using a probabilistic model.

The system can generate the list of prioritized prospects by correlating evaluations or prioritizations (e.g., including searches) of the user network information and the third party information. In some implementations, the method includes using a probabilistic model to achieve such correlations.

The method may include generating the list of prioritized prospects by correlating a keyword search/prioritization of the user network information and a keyword search/prioritization of the third party information. The method may include generating the list of prioritized prospects by correlating a keyword search/prioritization of the user network information and a parameter search/prioritization of the user network information. The method may include generating the list of prioritized prospects by correlating a keyword search/prioritization of the user network information and a parameter search/prioritization of the third party information. The method may include generating the list of prioritized prospects by correlating a keyword search/prioritization of the third party information and a parameter search/prioritization of the user network information. The method may include generating the list of prioritized prospects by correlating a keyword search/prioritization of the third party information and a parameter search/prioritization of the third party information. The method may include generating the list of prioritized prospects by correlating a parameter search/prioritization of the user network information and a parameter search/prioritization of the third party information.

The method may comprise rank-ordering the prioritized prospects. In some cases, relevance can be determined using a ranking algorithm. Such ranking can allow the system to prioritize search results. For instance, a machine learning engine configured to implement a machine learning algorithm can be employed for use with systems provided herein (e.g., computer system 301 of FIG. 3). The ranking algorithm can consider one or a plurality of parameters to provide a rank-order of prioritized subjects. For instance, the ranking algorithm can rank or stratify prospective donors based on: number of previous campaign contributions; amount donated in previous campaigns; type of contribution, e.g. soft or hard contribution; type of employment; age; familial status; political affiliation; platform issues associated with prospective donor; e.g. economy, education, women's issues, health, values, religion, environment, etc.

The system may receive (e.g., in association with a fundraising request 201 from an organization or individual) information for use as default or recommended parameters. For example, the staff of a political campaign may provide responses to questions (e.g., meta-information) about the candidate, including demographic questions (e.g., age, ethnicity), biographic questions (e.g., birthplace, education, past employment), and political questions (e.g., political party, key platform issues, past offices). In some implementations, this information may be used to adjust or alter one or more subsequent steps of the method 200. In one example, biographic data such as educational institutions may be used in selecting or prioritizing the user network information collected in 204. In another example, political data such as key platform issues may be used to provide default or recommended values in keyword selection 203.

In some implementations, the method may include adjusting or altering one or more steps of the method 200 in response to configuration changes from users (individuals or organizations). For example, a fundraising organization may configure, as a preference, a lower (or higher) weighting of geographic factors in collecting user network information 204. As another example, a user may configure a higher (or lower) weighting of relationship strength factors in prospect prioritization 206. In yet another example, a user may configure (e.g., adjust or control, toggle higher or lower) weighting of any given parameter or factor (e.g., ethnicity). Such adjustments may be saved as preferences or reusable configurations, or may be used only once and not retained. In some implementations, a fundraising organization may define factors that individuals associated with the organization (e.g., as staff or volunteers) are not able to adjust.

In some implementations, the method may include adjusting or altering one or more steps of the method 200 in accordance with user-requested adjustments to user network and/or third-party information. In some cases, the method can include adjustments to contact identity matching between user network and third-party information about contacts based on direct feedback from users. For example, a user can provide feedback to the system that a contact found in both user network and third-party information are or are not actually the same person. In some cases, portions of third-party information used in prospect prioritization 206 may be adjusted based on additional details or overlays provided by users. For example, a user may provide feedback that an organization that one or more contacts have donated to in the past has ideological characteristics not correctly or adequately represented in the third-party information (e.g., a political organization represented as non-partisan or neutral is in the user's assessment actually partisan). These adjustments may in some situations apply only to the user providing feedback, or in the case of an organization providing feedback, the other individual users associated with that organization. In some cases, such adjustments may be found valuable and adopted system-wide for all users.

In some implementations, the method may include adjusting or altering one or more steps of the method 200 in accordance with information collected from various user network providers (e.g., as a feedback mechanism). For example, the method can include adjusting or altering an algorithm of the method 200 based on “buzz” (e.g., news, events, posts or trends related to prospects, keywords, parameters, attributes, types or any other criteria herein; general state, national or world news, events or trends). In some situations, the algorithm may self-modify based on the collected information. In some cases, collection, search or prioritization steps of the method 200 can be adjusted or altered. In some cases, keywords, parameters, attributes, types or any other criteria herein can be replaced, added, adjusted or altered in response to the collected information. For example, the system can automatically suggest or apply new/different keywords or parameters based on the collected information. In some cases, other steps of the method 200 can be adjusted or altered (e.g., selecting step 207 or contacting step 208). Further, one or more steps may be added to the method 200 in response to the collected information. Any description herein of adjusting, altering or adding steps and/or criteria of the method 200 in response to collected user network information may equally apply to adjusting, altering or adding steps and/or criteria of the method 200 in response to collected third party information at least in some configurations. In some cases, a machine learning algorithm or a probabilistic model (e.g., a discriminative probabilistic model of maximum entropy) may be used by the system to learn from the collected information and/or to learn from the results/accuracy of past searches or prioritizations.

In an example of how network information can be overlaid with third party information, third party information (e.g., from FEC database) can reveal that a prospect has historically given to Democrats at the congressional level, and that the prospect has also given at the California state/local level for State Senators/Assemblymen. User network information can reveal that the prospect has “liked” John Smith on his/her Facebook page. The system may conclude that it is highly likely that the prospect will be interested in giving to John Smith if reached out to for fundraising.

In another example, a combination of user network information (e.g., posts by various individuals on a contact's Facebook page, the contact's LinkedIn connections, the contact's Twitter feeds, etc.) and third party information (e.g., privately maintained records of political contributions made by such individuals) may reveal a given trend or pattern in interests and/or level of giving among members of the contact's (contact) network. Such information may be used by the system to evaluate the contact as a prospect likely to give an amount similar to the amount (e.g., average amount) given by other members of the contact's network. In some cases, an interest (or set of interests) identified among members of the contact's network may be used by the system to evaluate the contact as a prospect likely to give to a cause aligned with this interest.

The method can include utilization of algorithms for weighting different information sources to rank or classify information (e.g., machine learning algorithms). For example, information from the FEC database may reveal that a person (e.g., a contact or prospect) donated $4,000 to the National Rifle Association (NRA), while information from a Facebook page may reveal that the same person also said that he/she supports a ban on semi-automatic guns. The two pieces of information (also “features” herein) may be reconciled by the system as, for example, a person that is a proud gun owner but also wants to increase gun safety mandated by law. The system may use a probabilistic model to reconcile and overlay information from various information sources.

In another example, a user may be a political campaign or committee that has a candidate that served as a Chief Executive Officer (CEO) in the past. The political campaign or committee may use the system to evaluate user network information and/or third party information associated with its contacts/prospects using past business experience as a criterion. The system may prioritize the user's contacts using keywords such as “CEO,” “founder,” “start-up,” “executive,” etc. In one instance, the system can harvest or extract (e.g., scrape) a prospect's public LinkedIn profile and find that the prospect started a company. The system may prioritize the user's contacts using, for example, parameters such as past executive or leadership experience, listed as an influential business leader, etc. In one instance, the system can collect third party information comprising work history, personal biography or FEC data, and find that the prospect was an executive in multiple companies, a serial entrepreneur or an investor.

In some implementations, the method 200 can include outputting the list of prioritized prospects generated in step 206. The list of prioritized prospects may be provided on a user interface. In some implementations, the system may allow the user to revise the list of prioritized prospects (e.g., using interactive features provided on the user interface).

Further, the method can include presenting at least a portion of the user network information (or information derived therefrom) to the user. The user network information presented to the user can include collected, analyzed or otherwise manipulated information or data. The method can also include presenting at least a portion of the third party information (or information derived therefrom) to the user. The third party information presented to the user can include collected, analyzed or otherwise manipulated information or data. The information presented to the user may be provided on the user interface.

Next, in a seventh step 207, the method can include selecting a subset of prioritized prospects. The subset may be selected from the list of prioritized prospects generated in step 206. In some cases, the list of prioritized prospects can include prioritization groups. For example, the list may comprise a first group with a high likelihood to donate, a second group with a medium likelihood to donate, and a third group with a low likelihood to donate. The prioritization groups may be refined or made more granular (e.g., in accordance with user preferences or settings). In some cases, the list of prioritized prospects can be ranked (e.g., in ascending or descending order of relevance). The subset of prioritized prospects may be selected by the user, by the system, or a combination thereof. For example, the subset of prioritized prospects can be automatically selected by the system.

In an eighth step 208, the method can include contacting the subset of prioritized prospects selected in step 207. In some cases, the prospects contacted are invitees to a fundraising event. In some examples, the number of prospects contacted is a fixed percentage of the individuals on the list of prioritized prospects (also “list” herein). In one example, all individuals on the list are contacted. In another example, the percentage of prospects on the list that are contacted is a function of the total number of individuals on the list. For instance, only the top 100 individuals from a list consisting of at least about 1000 individuals may be contacted. In other examples, between about 50% to about 75%, between about 20% to about 50%, or between about 30% to about 60% of the individuals on the list are contacted.

Contacting prospects may include customization of emails or other communication channels between the user and the prospects being contacted. In some cases, the system can aid the user in customizing the user's emails (e.g., the system can make suggestions, the system can customize a portion of the emails and let the user make changes or reconfigure the emails, the system can customize emails based on user settings, etc.). In other cases, the system can automatically customize the user's email. The user may or may not have the capability to override or reconfigure the customized emails generated by the system. In some examples, the user can add on or edit automatically generated customized emails.

In some implementations, customization (e.g., communication customization, such as, for example, customization of electronic messages) may be based on a template from a user (e.g., an organization). For example, customization may be based on one or more message templates supplied by a fundraising organization (also “user organization” herein). Such templates may provide, for example, specific visual elements (e.g., logo, layout, content density, content organization, etc.) to be used in communicating with prospects. In some cases, templates may include default or recommended content (e.g., phrases, wording, visual elements, etc.), or may provide multiple alternative options for specific portions of messages to prospects (e.g., via a series of selection steps, or via drop-down lists or other graphical user interface features).

Customization may be implemented according to various criteria (e.g., respectfulness). For example, emails sent to individual prospects may be configured to be respectful to the individual's background, values and preferences. For example, when raising donations for a political cause, the user can contact a prospect that is traditionally not affiliated with the party for which the user is raising donations. The method 200 can allow the user to consider information known about the prospect (e.g., the user network information collected in step 204, the third party information collected in step 205, the results from the analysis, including correlation or manipulation, of the aforementioned information during prioritization in step 206) to ensure that the email to the prospect is composed with care and does not damage the user's relationship with the prospect. For example, the method can include customizing emails to the subset of prioritized prospects being contacted based on the collected user network information or information derived therefrom, the collected third party information or information derived therefrom, the keyword, the parameter, the attribute of the cause, the type of the cause, or a combination thereof.

In some implementations, the customization can be performed by the user. The system may suggest information or factors relevant (e.g., most important) to an individual prospect or a subset of prospects (e.g., flagged information or factors based on the collected information and/or search/prioritization results, or information or factors derived therefrom) to the user, thereby aiding the user in customizing emails to individual prospects. The system may present the relevant information or factors to the user on a user interface. For example, the system can present the relevant information or factors to the user after being prompted by the user (e.g., through a click of the mouse) or automatically. In some cases, only a given portion of information relating to the prospect can be displayed (e.g., less than about 5%, 10%, 20%, 50%, 75% or more of all the information associated with a prospect or of the information used during search/prioritization can be presented to the user). In other implementations, at least a portion of the customization can be automatically performed (e.g., prefilled or precomposed) by the system. In some cases, the user can choose to override the automatically generated customization. In some cases, the automatic customization can self-modify based on user behavior. In some implementations, the extent or configuration of suggested information or factors, or of automatic customization can be configured through user settings.

The methods of the disclosure may be applied to fundraising organizations (user organizations) to identify prospective customers and/or for other business development purposes (e.g., for marketing). In such implementations, the method 200 (and system or platform for implementing the method) may be used to identify customer prospects among contacts (e.g., friends, business partners, colleagues, etc.) of existing customers (individuals). The customer prospects may be interested in buying or using the organization's product or service. The method 200 may be adapted to implement outreach for purposes other than fundraising. For example, a customer outreach program may be implemented in a manner similar to a political campaign. Various metrics (e.g., keywords, parameters, attributes, etc.) associated with the method may be adapted accordingly. For example, a relevant parameter in a customer outreach method may be “mentality” or indication of positive or negative attitude or propensity toward the product or service provided by the organization (e.g., mindset such as, for example, public relations stance and/or company culture, need, or other indication). In some cases, the existing customer (or any other individual 105 herein) may get a referral bonus or an acquisition payment. Thus, in some implementations, the disclosure provides a computer-implemented method for identifying customers. The method can comprise receiving, from a user, a request for identifying customers for a cause (e.g., increasing bottom line) having an attribute (e.g., “health,” “cancer,” “environment,” “environmental conscience,” “financial safety,” “energy efficiency” or another attribute associated with the company or its product/service). The method can further include collecting prospects and providing a keyword (e.g., “health” or “environment”) associated with the cause. The method can further include collecting user network information associated with at least one of the prospects from a user network provider, and storing at least a portion of the user network information or information derived therefrom in a computer memory. Further, third party information associated with at least one of the prospects can be collected from a third party provider, and at least a portion of the third party information or information derived therefrom can be stored in a computer memory. With the aid of a computer processor, the method may further generate a list of prioritized prospects using (i) the user network information and the keyword, or (ii) the third party information and the keyword. In some cases, the method can include generating the list of prioritized prospects using a parameter (e.g., “mentality”) associated with a type (e.g., “customer acquisition” or “business development”) of the cause. For instance, in one example, the method 200 can be adapted to extract, stratify, and rank various metrics (e.g., keywords, parameters, attributes, etc.) that can help a company that sells solar panels identify a customer base. For instance, the system and computer program products of the disclosure can identify and rank individuals that have contributed to environmentally friendly organizations or political campaigns to provide a ranked list of prospective customers.

In another aspect of the disclosure, a system for implementing the methods of the disclosure is provided. The computer system can include search and analysis engines for allowing the user to generate a list of prioritized prospects. The computer system can also include search and analysis engines for allowing the user to customize communication and outreach to selected prospects. The computer system can allow the user to input information (e.g., keywords), view information (e.g., prioritization or customization results), make selections or edits, or otherwise interact with the system to implement the methods of the disclosure.

FIG. 3 shows a system 300 for implementing methods of the disclosure. The system 300 may be adapted to interface with various entities or systems associated with such entities, such as, for example, a third party provider or a system associated with a third party provider, a user network provider or a system associated with a user network provider, or a user or a system associated with a user. The systems associated with entities can include computer systems.

The system 300 can include a computer system 301 that is in communication with a first entity 302 (e.g., a third party provider), a second entity 303 (e.g., a user network provider) and a third entity 304 (e.g., a user). The system 300 can interface with an entity with the aid of a network 305. The network 305 may include the Internet, an intranet and the extranet. For example, the network 305 can be the Internet or an intranet that is operatively coupled to the Internet. In some contexts, the network 305 can be referred to as the “cloud.” In some cases, multiple networks can be used for interfacing with each entity or for interfacing with different entities.

The computer system (“system”) 301 includes a memory location 306, a communications interface 307, a display interface 308 and, in some cases, a data storage unit 309, which are all operatively coupled to a processor 310, such as a central processing unit (CPU) or a plurality of CPU's for parallel processing. The system 301 may include one or more servers, such as, for example, data or database servers, file servers, web servers, or application servers. The system 301 can have software that is configured to operate on various operating systems, such as Linux-based operating systems, Windows-based operating systems, or any other operating system described herein. The operating system can reside on a memory location of the system 301. In some cases, the operating system can be provided by cloud computing.

The memory location 306 may include one or more of flash memory, cache and a hard disk. In some situations, the memory location 306 is read-only memory (ROM) or random-access memory (RAM), to name a few examples. The data storage unit 309 can include one or more hard disks, memory and/or cache for data transfer and storage. The data storage unit 309 can include one or more databases, such as, for example, document-oriented database (e.g., MongoDB), relational databases (e.g., Microsoft® SQL Server, mySQL™, Oracle®), non-relational databases, object or object-oriented databases, entity-relationship model databases, associative databases, and XML databases. In some cases, the system 301 further includes a data warehouse for storing information, such as user information. In some examples, the data warehouse resides on a computer system remote from the system 301. In further examples, one or more components of the system 301 can reside on a computer system remote from the system 301. In some cases, remote components may be added in addition to components residing on the system 301. For example, data storage units 312 and 313, a processor 314, or a server 315 can be in communication with the computer system 301 over the network 305.

The communications interface 307 can include a network interface for allowing the system 301 to interact with the network 305, which may include an intranet, including other systems and subsystems, and the Internet, including the World Wide Web. In some cases, the communications interface 307 includes interfaces for enabling the system 300 to interact with multiple networks. The system 301 may include one or more communication interfaces or ports (COM PORTS), or one or more input/output (I/O) modules, such as an I/O interface.

In some situations, the communications interface 307 functions with the system 301 to wirelessly interface with the network 305. In such a case, the communications interface 307 includes a wireless interface (e.g., 2G, 3G, 4G, long term evolution (LTE), WiFi, Bluetooth) that brings the system 301 in wireless communication with a wireless access point that is in communication with the network 305.

The communications interface 307 may be configured to allow the system 301 to collect information from various sources (e.g., user network information from user network providers, or third party information from third party providers). For example, the system 301 can be programmed or otherwise configured to access user network information available in social media (e.g., web-based and mobile technologies which may or may not be associated with social networks, such as weblogs, homepages, private portions of social networks, and public portions of social networks), email clients or archives (e.g., Microsoft® Outlook, Google® Gmail, Mozilla® Thunderbird, Apple® Mail, Eudora®, Symantec® Enterprise Vault), personal organizers comprising an individual's personal or business contacts (e.g., Microsoft® Outlook, Apple® Contacts, digitized Rolodex records), or calendars (e.g., Microsoft® Outlook, Google® Calendar, Apple® Calendar).

The system 301 may include a data mining module adapted to search for user network information in various source locations, such as email accounts, calendars, organizers and various network sources, such as social networking accounts (e.g., Facebook®, Foursquare®, Google+, LinkedIn®, Twitter®, Instagram®, Myspace®) or on publisher sites, such as, for example, weblogs. Information provided by user network providers can include overlapping content and non-overlapping content. For example, the system 301 may be configured to collect information from multiple user network providers 302. In one example, information may be collected from a user network provider serving user network media information relating to social activities and networks of the user 304, and a user network provider serving user network media information relating to professional activities and networks of the user 304.

In some cases, the system 301 may be configured for data mining, extract, transform and load (ETL), or spidering (e.g., Web Spidering, where the system fetches data from remote systems over a network and accesses an Application Programming Interface (API) or parses the resulting markup) operations, which may permit the system to load information from a raw data source (or mined data). The information can be loaded into a data warehouse. In some examples, the information can be loaded into a memory location (e.g., the memory location 306), or a data storage unit (e.g., the data storage unit 309). In some examples, at least a portion of the information can be processed by the system 301 before being loaded into memory. In some cases, one or more credentials are provided in order to access data (e.g., one or more credentials are provided for access through an API specific to a third party platform). In some implementations, such credentials are provided to the system 301 by the user 304. In some cases, the credentials can be provided by the user and stored as part of a user profile or user data, as described in greater detail elsewhere herein.

In another example, the system 301 can be configured to access third party information made available by third party providers. Access to various third party information sources (e.g., databases maintained by third party providers) may be open (e.g., public access) or restricted (e.g., private access). In some cases, third party information can be made available to the system 301 based on access type. In an example, extraction and manipulation of data from open access sources may be less restrictive than extraction and manipulation of data from restricted access sources, and vice versa. In some cases, information sources with restricted access can have multiple access levels, which may be associated with different data extraction and manipulation capabilities. For example, restricted access levels can be fee-based (e.g., subscription, pay according to access level, or pay per use based on metrics such as total times accessed, frequency of access, and amount of information accessed), or based on who is accessing the information and for what purpose (e.g., different pricing structure and/or data extraction and manipulation capabilities may apply to individuals and organizations, different pricing structure and/or data extraction and manipulation capabilities may apply to different types of organizations). Data extraction and manipulation capabilities may include, for example, searching, overlaying, organizing or formatting information stored in a database or provided via a server or web interface.

The amount and/or format of information collected by the system 301 from third party providers may depend on data extraction and manipulation capabilities. For example, when custom data manipulation is not configured or the data extraction and manipulation capabilities of the third party provider cannot be adequately tuned, a subset or all information provided by the third party provider may be collected by the system before data manipulation is performed by the system. In another example, when data extraction and manipulation capabilities provided by the third party provider can be tuned or are compatible with the system 301, or when custom data extraction and manipulation capabilities can be implemented, a subset of the information provided by the third party provider, or information derived from the information provided by the third party provider can be collected by the system 301.

Data extraction and manipulation of user network information may be implemented in a similar fashion as data extraction and manipulation of third party information. Any description of access, collection, data extraction and manipulation of third party information herein may also be applied to access, collection, data extraction and manipulation of user network information, and vice versa.

The data (also “information” herein, such as, for example, user network information or third party information) collected via the communications interface 307 may include raw data, mined data, data extracted in accordance with given data extraction and manipulation capabilities, as well as data derived therefrom. Further, the collected data may be used by the system 301 to derive data (e.g., derived metrics, metadata). At least a portion of the data collected and/or derived may be stored in a computer memory, such as the memory location 306, the data storage units 309, 312 or 313, a memory (not shown) of the computer system of the user 304, a data warehouse, or a combination thereof. The computer memory can be located on the system 301, in a remote location in communication with the system 301, or on a user system 304. For example, the stored information may be distributed over multiple local or remote locations. Information from various sources may be stored together, separately, or a combination thereof. In some cases, the derived information can be stored together with a portion of the collected information (e.g., information from which it was derived). In some instances, only derived information may be stored. In some examples, less than about 1%, less than about 5%, less than about 10%, less than about 20%, less than about 30%, less than about 40%, less than about 50%, less than about 75%, less than about 90%, or 100% or less of the information collected may be temporarily or permanently stored. In some cases, at least about 1%, at least about 5%, at least about 10%, at least about 20%, at least about 30%, at least about 40%, at least about 50%, at least about 75%, at least about 90%, or even 100% of the information derived may be temporarily or permanently stored. In some implementations, information can be stored substantially or exclusively in the memory of the computer system of the user 304. In such a case, information may be temporarily stored by the system 301 during processing in accordance with methods of the disclosure before being stored by the user 304. Information may be stored automatically, manually (e.g., by the user), or a combination thereof.

The computer system of the user 304 can include, for example, a personal computer (PC), a terminal, a server, a slate or tablet PC (e.g., Apple® iPad®, Samsung Galaxy Tab), a smart phone (e.g., Apple® iPhone®, an Android®-based phone), a netbook, a personal digital assistant (e.g., Palm® handheld), or systems and devices with optional computer network connectivity (e.g., video game console, television, video player, digital music player, vehicle). For example, the system 304 can be a user terminal comprising a display and an input device such as a keyboard, a pointing device (e.g., mouse, trackball, track pad, joystick, game controller, stylus), a touch screen, a microphone to capture voice or other sound input, or a video camera or other sensor to capture motion or visual input (e.g., Kinect, Leap Motion). In another example, the system 304 can comprise a memory location (e.g., a hard disk) and a processor in addition to the display and the input device. In some cases, the system 304 may also comprise a data storage unit. The computer system 304 can comprise an operating system, such as, for example, a server operating system (e.g., FreeBSD, OpenBSD, NetBSD®, Linux, Apple® Mac OS X Server®, Oracle® Solaris®, Windows Server®, and Novell® NetWare®), a personal computer operating system (e.g., Microsoft® Windows®, Apple® Mac OS X®, UNIX®, and UNIX-like operating systems such as GNU/Linux®), or a mobile or smart phone operating system (e.g., Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®). In some implementations, the operating system is provided by cloud computing.

The system 300 can comprise a plurality of users 304. In some cases, the users can be independent entities. In some cases, a user hierarchy can exist. For example, a user can provide seats (e.g., access to the system 300) to one or more other users or dependent entities. In such cases, the seats may have overlapping functionality or settings. The seats may have independent functionality. In some examples, the overlapping functionality can be overridden. In other examples, independent functionality can be added in addition to overlapping functionality. In some implementations, at least a portion of the user computers and/or user terminals 304 may be interconnected in a network (e.g., a local network). Further, in some implementations, one or more user computers/terminals are capable of hosting servers.

Information may be stored locally by the user 304 (e.g., in a memory location or a data storage unit on the system 304), or uploaded to one or more cloud memory storage units (e.g., data storage units 312 and 313). In some examples, information from multiple users 304 can be stored remotely in the same memory location or data storage unit. In some cases, the memory location or data storage unit may be partitioned to allow for separation of information associated with individual users. In some cases, non-partitioned information storage may be used. In this configuration, information associated with individual users may be separated through, for example, tagging. The system 300 may be configured to allow restricted memory storage access. For example, access to information associated with an individual user may be restricted to only that user. In some cases, when multiple users are related through a user hierarchy, access to at least a portion of information associated with an individual user (e.g., a dependent user having a seat provided by an independent user) may be restricted to the individual user (e.g., the dependent user), at least a portion of the information associated with the independent user may be accessible to another user (e.g., the independent user), or a combination thereof. In another example, at least a portion or all information associated with an individual user can be stored locally by the user 304. In yet another example, at least a portion or all information associated with an individual can be released by the user (e.g., stored on the system 300 and/or made accessible to other users or entities associated with the system 300). In some cases, the information released can be controlled via user settings. In some cases, the information released can be controlled by default settings.

In some instances, a document-oriented database (e.g., MongoDB) can be used to store information on the system 300. The system may make local aggregate of the information (e.g., social media or other user network information) on the user system 304. In some cases, the information may belong to the end user 304 and may not be stored elsewhere on the system 300. For example, the user's contacts and information gathered by the user can belong to the user (e.g., the information may only be available to the user). In such cases, the information is only to be manipulated by the system 300 to give best results to the user 304. The user may choose to save output to a local hard drive and/or elsewhere on the system 300 (e.g., on server 311 or 315). In some implementations, a portion of the information may or may not be made available to other users or entities associated with the system 300.

In an example, a contact associated with the user may have a Twitter account in which he/she is openly talking about being in support of gun control. The system may extract or derive this preference and store it, for example, with a user profile. In some cases, the system may also store the original (e.g., raw) content from which this information was derived. In some cases, the stored raw information may be used again by the system. For example, an improved preference extraction method or algorithm can be implemented on the system in the future that may be able to extract or derive more (or different) information than in the past. In some cases, the user may wish to review the original content from which the pro-gun control preference was derived. In some examples, the user may review the information derived by the system for accuracy (e.g., the prospect may be against gun control but may have expressed their preference in a tortuous way). In some cases, the user may override or correct system information as needed.

Information may be communicated between various components of the system 300 over the network 305 to facilitate processing and/or storage. As an example, software and algorithms can be configured to be processed locally by the user (e.g., by the processor on the user system 304), remotely (e.g., by the processor 314), remotely via a cloud server (e.g., server 315), remotely by the system 301 (e.g., by the processor 310), or a combination thereof. In some cases, when user terminals are used, software and algorithms may be configured to only be processed remotely. In some implementations, software and associated data of the system 300 can be centrally hosted on the cloud (e.g., on the computer system 301, the data storage units 312 and 313, the processor 314, the server 315, or a combination thereof) and accessed by users using a thin client via a web browser (e.g., via the network 305). In some examples, a client-server architecture is provided that may require installation of software on the user system 304. In some examples, different user access levels may be provided. For example, individual users may be able to access the system 300 at any or at limited levels of the system hierarchy.

A user interface (UI) may be configured to allow a user to interact with systems of the disclosure, such as for prioritizing and contacting prospects to raise donations. The UI, such as a graphical user interface (GUI) having various graphical, textual, audio and video elements, can be provided on a display of, for example, an electronic device of the user 304. The display can be a capacitive or resistive touch display, or a head-mountable display (e.g., Google® Glass). Such displays can be used with other systems and methods of the disclosure.

The user interface can be configured to receive input from the user. For example, the user interface can include a text field to permit a user to input a keyword or a user login or authentication information. In another example, the user interface can include a check box, or a drop-down, pull-down or other type of menu to allow a user to select, for example, a given cause (e.g., from a list of causes) or a keyword suggested by the system.

The user interface can be configured to provide output to the user. Following a request from the user 304, the system can perform one or more steps of a method for raising donations (e.g., the method 200 in FIG. 2). In some cases, the system may request user input or validation as a step is performed. In some cases, the system may perform a given number of steps and provide results (e.g., the results of method 200) to the user 304 on the user interface. In some cases, the results displayed to the user may be prioritized (e.g., ranked) or customized in accordance with methods of the disclosure.

The user interface can allow individual users to access their information, which may be stored on the user system 304 or elsewhere on the system 300. The user's information may include, but is not limited to, user settings, keywords, parameters, causes, information about associated users (e.g., independent or dependent users in a user hierarchy), authentication information for various information providers (e.g., Facebook or LinkedIn passwords), user contacts, lists of prioritized prospects, customized emails, or contacts. In some examples, the user interface can be customized by the user. For example, the system 301 can permit the user 304 to create a user profile. The user profile may be configured to allow the user to adjust what information is presented and how it is presented.

In some examples, the user interface is a web-based user interface (also “web interface” herein) that is configured (e.g., programmed) to be accessed using an Internet (or web) browser (e.g., Microsoft® Internet Explorer®, Mozilla-Firefox®, Google® Chrome, Apple® Safari®, Opera Software® Opera®, and KDE Konqueror, or mobile web browsers such as Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser) of a computer system of the user 304. In an example, the user can utilize the system 300 to raise donations via a password-protected, interactive web site.

In some examples, the user interface can be provided through client software. The systems and methods for raising donations may include a computer program having a sequence of instructions, executable by a processor, written to perform a specified task. Computer readable instructions may be implemented as program modules, such as functions, objects, Application Programming Interfaces (APIs), data structures, and the like, that perform particular tasks or implement particular abstract data types. The functionality of the computer readable instructions may be combined or distributed in various environments (e.g., one or more locations, one or more software modules hosted on one or more computer systems or cloud computing platforms, one or more web applications, one or more mobile applications, one or more standalone applications, one or more web browser plug-ins, extensions, add-ins, or add-ons, or combinations thereof).

The system 300 may implement a method (e.g., method 200 in FIG. 2) in accordance with a setting, such as, for example, a data driven setting or a self-modifying setting based on data usage (e.g., wherein the system automatically recognizes user behavior), a default setting (e.g., provided on the system), or a runtime user setting (e.g., allowing the user to provide settings at runtime). Systems of the disclosure may allow the user to set preferences and/or make selections. The preferences and/or selections may be used in a feedback loop to control one or more steps of the methods of the disclosure. In some cases, limited user settings may be provided. In one example, the system may display a “best” list (e.g., suggested settings). In another example, the system may provide runtime parameters that allow the user to filter information (e.g., filter out information sources, filter out parameters or keywords, etc.). For example, a filter may be provided on the user interface that allows the user to select or unselect keywords “democrats,” “republicans,” “independents,” and so on.

Aspects of systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable (also “computer-executable” herein) code can be stored on an electronic storage unit, such as one or more memory (e.g., ROM, RAM) or one or more hard disks. Examples of hard disks include magnetic and solid state recording media. “Storage” type media can include any or all of the tangible memory of computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may permit loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD or CD-ROM, a DVD or DVD-ROM, any other optical medium, punch cards paper tape, any other physical storage medium with patterns of holes, a RAM (e.g., DRAM, FRAM or PRAM), a ROM, a PROM and/or EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution. Examples of transfers of data and/or instructions by carrier waves include, but are not limited to, transfers (uploads, downloads, email, etc.) over the Internet and/or other computer networks via one or more data transfer protocols (e.g., TCP, UDP, HTTP, FTP, SMTP, etc.).

Aspects of systems and methods described herein may be implemented with the aid of a computer processor, or implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discreet logic (sequential and combinatorial), custom devices, fuzzy (neural network) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc. In some cases, code that is executable by a single processor can be executed by a plurality of processors, such as in a parallel processor environment or distributed computing fashion. Code that is executable by a plurality of processors may be executed by a single processor.

### Computer Modules.

A computer program product comprising a computer-readable medium having computer-executable code encoded therein can be configured to implement a method for raising donations. The computer program product can have one or a plurality of modules that are configured to provide a system for implementing one or more components of a method for raising donations.

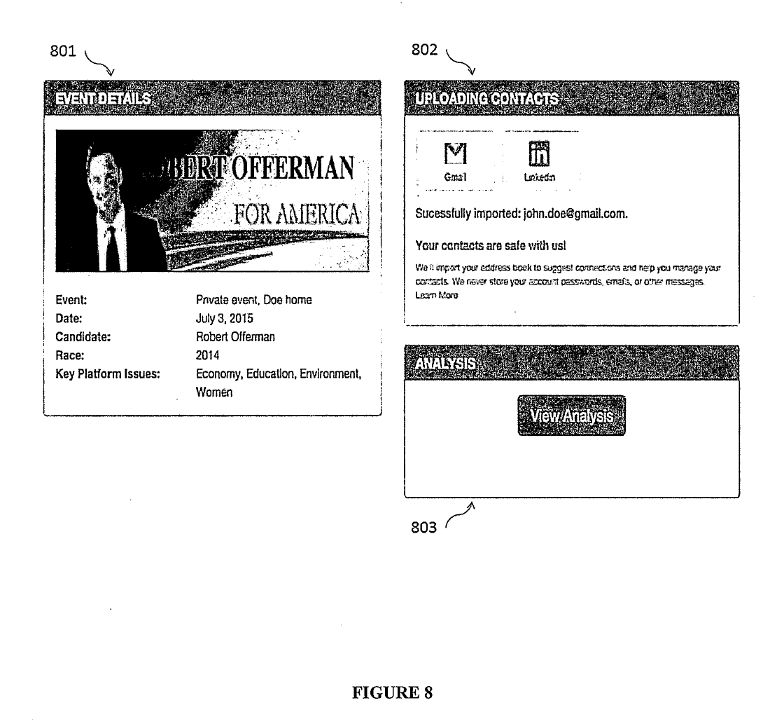

A computer program product and a system of the disclosure can be configured to provide a user input module. A user can provide information into the input module, such as, for example, the name, date, race, and key platform issues used to create campaign profile illustrated in FIG. 8 801. A user input module can receive a request for raising a donation for a cause. A user input module can be used to receive data that are added to a prospect database. A user input module can be configured to extract data from a social media profile, for instance, the data illustrated in FIG. 8 802.

A computer program product and a system of the disclosure can be configured to provide a prospect module. A prospect module can be configured to identify a prospect based on a request. The prospect module can be configured to identify a prospect that is listed on a database of prospects. The prospect module can be configured to rank and stratify data associated with a prospect, for instance, number of previous campaign contributions; amount donated in previous campaigns; type of contribution, e.g. soft or hard monetary contribution; type of employment; age; familial status; political affiliation; platform issues associated with prospective donor; e.g. economy, education, women's issues, environment, etc.

A computer program product and a system of the disclosure can be configured to provide a keyword module. A keyword module can be configured to determine a keyword associated with a cause. In some cases, a keyword is a word that is extracted from a user's profile. The keyword can be entered by a user, or identified by the keyword module by a search of any information system or database provided herein. In some embodiments, a keyword engine creates a new keyword based on another keyword. The keyword module can then use the newly-created keyword in any way that any other keyword herein is used.

A computer program product and a system of the disclosure can be configured to provide an information module. An information module can obtain, extract, collect, or search for information on any information system or database provided herein. In some cases, the information module is configured to obtain user network information associated with a prospect from a user network. In some cases, the information module is configured to obtain third party information associated with a prospect from a third party provider.

A computer program product and a system of the disclosure can be configured to provide a comparison module. A comparison module can be configured to stratify and rank prospects based on various metrics described herein. A comparison module can be configured to determine a relative likelihood of a prospect making a donation to a cause in comparison to another prospect based on a user network information, a third party information, and a keyword associated with said cause. A comparison module can assign a weight to each keyword in determining a relative likelihood of a prospect making a donation.

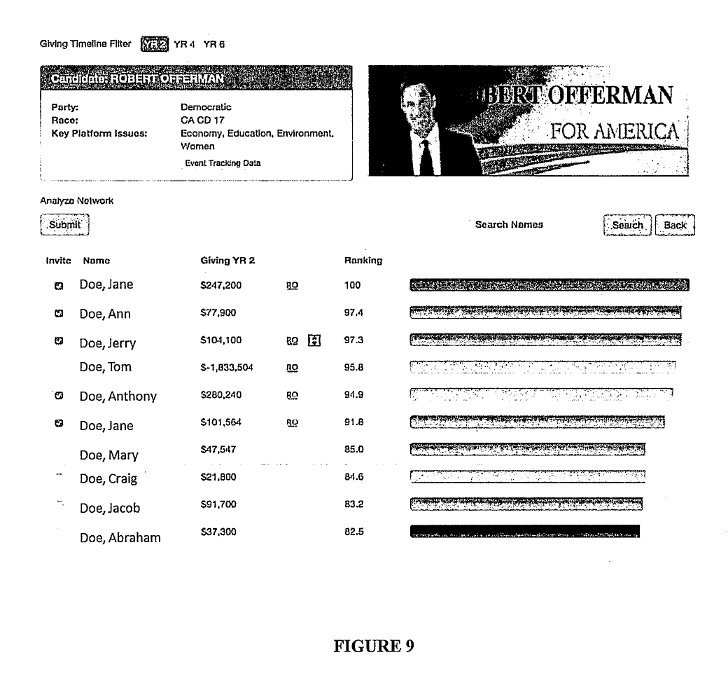

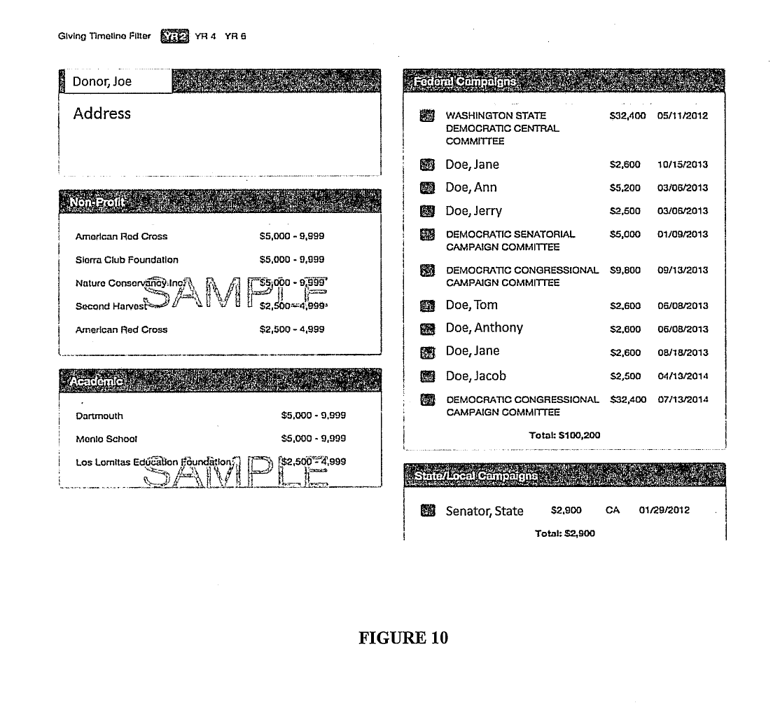

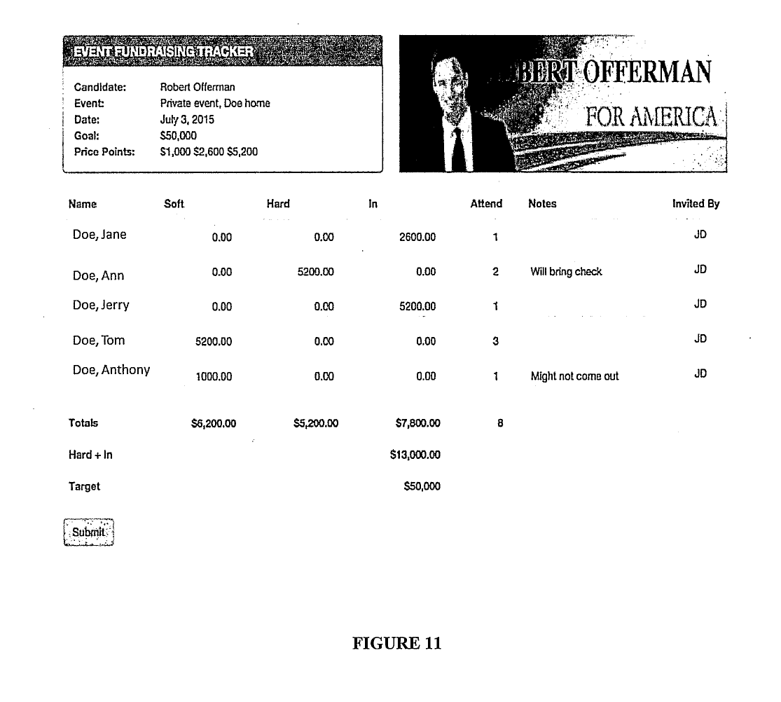

A computer program product and a system of the disclosure can be configured to provide an output module. An output module can display, for example: a) a full window representation of a ranking of prospective donors provided by the system and computer-program products of the invention (representative window illustrated in FIG. 9); b) third party information that can be transformed by a system of the invention to provide a stratified ranking of prospective donors (representative third-party information is illustrated in FIG. 10); and c) representative parameters that can form a database of third party information associated with at least one of said prospects (representative parameters are illustrated in FIG. 11). An output module can display any prospect information stored in a database to an authorized user.

A computer program product and a system of the disclosure can be configured to provide a ranking module. A ranking module can rank prospects based on any of the metrics described herein, for example, to provide a rank order of prospects suggesting relative likelihoods that any of the prospects would make a donation to a cause. Ranking can be used to prepare a list of prospects, to prioritize output, to prioritize customized electronic messages, and to improve the overall likelihood of success by delineating the more favorable prospects from others. A ranking rules engine can be implemented to provide for versatility in customizing the ranking process based on the user's needs, or based on the available information. In some embodiments, the ranking module or the ranking rules engine uses self-modifying code to improve or refine a ranking algorithm to provide better or more useful information to the user.

A computer program product and a system of the disclosure can be configured to provide a scoring module. A scoring module can score prospects based on any of the metrics described herein, for example, to provide a score that suggests a likelihood of making a donation to a cause. Scores are useful as a metric for the ranking module. Scores can be refined and a scoring rules engine can be implemented to provide for versatility in customizing the scoring process based on the user's needs, or based on the available information. In some embodiments, the scoring module or the scoring rules engine uses self-modifying code to improve or refine a scoring algorithm to provide better or more useful information to the user.

### Computer Architectures.

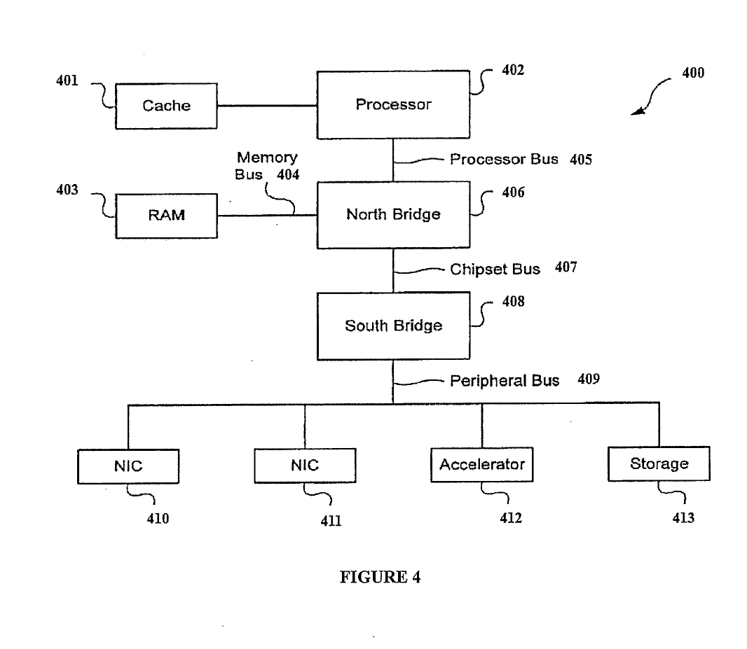

Various computer architectures are suitable for use with the invention. FIG. 4 is a block diagram illustrating a first example architecture of a computer system 400 that can be used in connection with example embodiments of the present invention. As depicted in FIG. 4, the example computer system can include a processor 402 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

As illustrated in FIG. 4, a high speed cache 401 can be connected to, or incorporated in, the processor 402 to provide a high speed memory for instructions or data that have been recently, or are frequently, used by processor 402. The processor 402 is connected to a north bridge 406 by a processor bus 405. The north bridge 406 is connected to random access memory (RAM) 403 by a memory bus 404 and manages access to the RAM 403 by the processor 402. The north bridge 406 is also connected to a south bridge 408 by a chipset bus 407. The south bridge 408 is, in turn, connected to a peripheral bus 409. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 409. In some architectures, the functionality of the north bridge can be incorporated into the processor instead of using a separate north bridge chip.

In some embodiments, system 400 can include an accelerator card 412 attached to the peripheral bus 409. The accelerator can include field programmable gate arrays (FPGAs) or other hardware for accelerating certain processing.

Software and data are stored in external storage 413 and can be loaded into RAM 403 and/or cache 401 for use by the processor. The system 400 includes an operating system for managing system resources; non-limiting examples of operating systems include: Linux, Windows™, MACOS™, BlackBerry OS™, iOS™, Google Jelly Bean and other functionally-equivalent operating systems, as well as application software running on top of the operating system.

In this example, system 400 also includes network interface cards (NICs) 410 and 411 connected to the peripheral bus for providing network interfaces to external storage, such as Network Attached Storage (NAS) and other computer systems that can be used for distributed parallel processing.

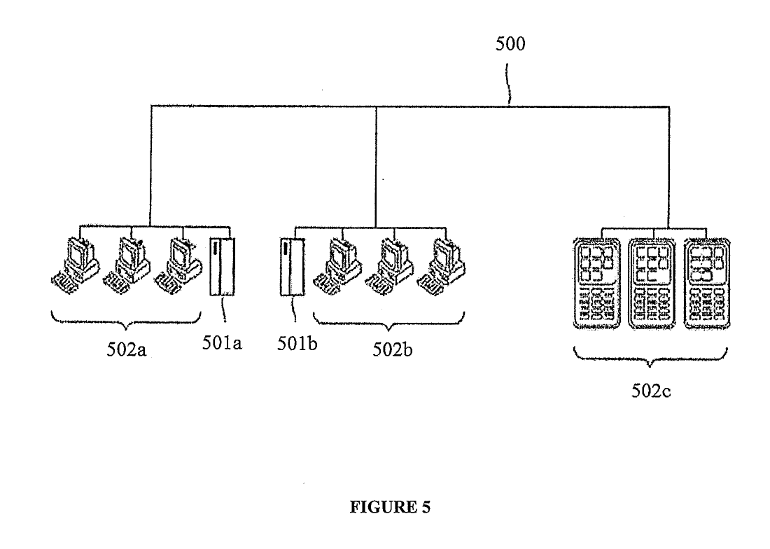

FIG. 5 is a diagram showing a network 500 with a plurality of computer systems 502a, and 502b, a plurality of cell phones and personal data assistants 502c, and Network Attached Storage (NAS) 501a, and 501b. In some embodiments, systems 502a, 502b, and 502c can manage data storage and optimize data access for data stored in Network Attached Storage (NAS) 501a and 502b. A mathematical model can be used for the data and be evaluated using distributed parallel processing across computer systems 502a, and 502b, and cell phone and personal data assistant systems 502c. Computer systems 502a, and 502b, and cell phone and personal data assistant systems 502c can also provide parallel processing for adaptive data restructuring of the data stored in Network Attached Storage (NAS) 501a and 501b. FIG. 5 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

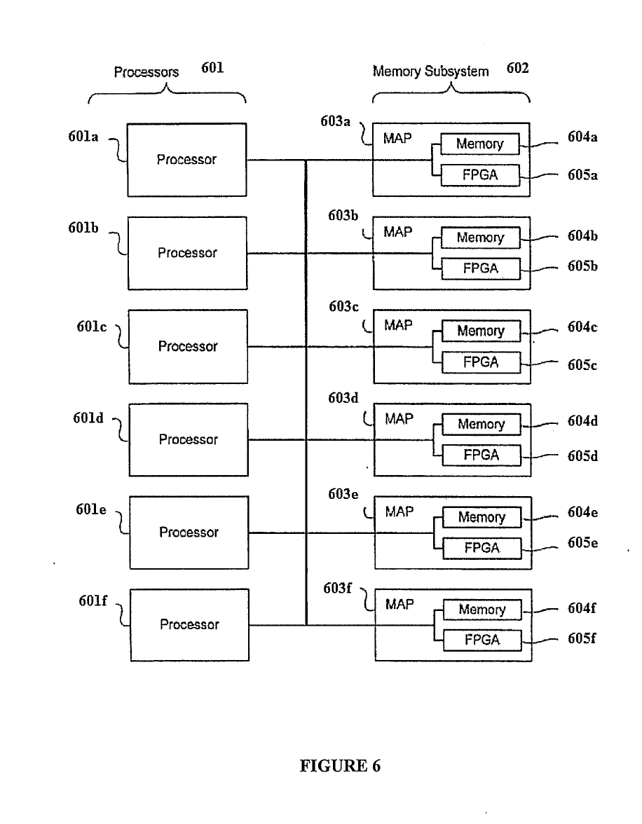

FIG. 6 is a block diagram of a multiprocessor computer system using a shared virtual address memory space. The system includes a plurality of processors 601a-f that can access a shared memory subsystem 602. The system incorporates a plurality of programmable hardware memory algorithm processors (MAPs) 603a-f in the memory subsystem 602. Each MAP 603a-f can comprise a memory 604a-f and one or more field programmable gate arrays (FPGAs) 605a-f. The MAP provides a configurable functional unit and particular algorithms or portions of algorithms can be provided to the FPGAs 605a-f for processing in close coordination with a respective processor. In this example, each MAP is globally accessible by all of the processors for these purposes. In one configuration, each MAP can use Direct Memory Access (DMA) to access an associated memory 604a-f, allowing it to execute tasks independently of, and asynchronously from, the respective microprocessor 601a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 6, system on chips (SOCs), application specific integrated circuits (ASICs), or other processing and logic elements. For example, the Set Processor and Optimizer can be implemented with hardware acceleration through the use of a hardware accelerator card, such as accelerator card 412 illustrated in FIG. 4.

### Products of the Invention.

In some embodiments, the invention described herein comprises a computer program product and a system adapted to stratify and rank a list of individuals based on one or more metrics. A product of the invention can be a ranked or stratified list of individuals. A ranked or stratified list of individuals can be, for example, produced and/or transmitted in a geographic location that comprises the same country as the user of the system and computer-program products of the disclosure. A ranked or stratified list of individuals can be, for example, produced and/or transmitted from a geographic location in one country and a user of the system/computer program product can be physically present in a different country. In some embodiments, the product of the invention is the computer program data product comprising a ranked, stratified, or unranked list of individuals that can be accessed and navigated by a user. In some embodiments, the data accessed by a system of the invention is a computer program product that can be transmitted from one of a plurality of geographic locations 701 to a user 702 (FIG. 7). Data from a system and a computer-program product of the disclosure can be transmitted back and forth among a plurality of geographic locations, for example, by a network, a secure network, an insecure network, an interne, or an intranet. In some embodiments, a ranked, stratified, or unranked list of individuals is a physical and tangible product.

### EXAMPLES

### Example 1

### Creating an Event Profile

An individual, “John Doe” hosts a fundraising event for candidate “Robert Offerman.” The “Robert Offerman” campaign has an account that was created with the system and computer program product of the disclosure. FIG. 8 illustrates a representative interface of a system and computer program product of the disclosure. The Robert Offerman campaign has provided a seat to the individual fundraiser John Doe at the Doe home 801.

801 illustrate the event details of the private fundraising event at the Doe home. John Doe uploads his contact information from social networks, such as Gmail® and LinkedIn®, into the system and computer program products described in the instant application. John Doe, Robert Offerman, or another user can select the analysis icon 803 to prompt the ranking, stratification, and other analysis of the data imported in 802. FIG. 9 illustrates a representative full window representation of a ranking of prospective donors provided by the system and computer-program products of the invention in analysis 803. The “Giving YR 2” listing corresponds to donations made in the last two years. The “Ranking” listing is created on a scale of 0 to 100 with the largest numbers corresponding to the greater likelihood of a prospective donor to make a donation.

Analysis 803 stratifies prospective donors based on: number of previous campaign contributions; amount donated in previous campaigns; type of contribution, e.g. soft or hard monetary contribution; type of employment; age; familial status; political affiliation; platform issues associated with prospective donor; e.g. economy, education, women's issues, environment, etc. Stratification of prospective donors in analysis 803 provides a Ranking (FIG. 9).

### Example 2

### Third Party Information

FIG. 10 illustrates representative third party information that was processed and transformed by a system of the invention in 803 to provide a ranking of prospective donors illustrated in FIG. 9. FIG. 10 illustrates past donations made by “Joe Donor” in the last two years to non-profit organizations, Academic institutions, Federal campaigns, and State/Local campaigns.

FIG. 11 illustrates representative parameters that can form a database of third party information associated with at least one of said prospects. The fundraiser (or co-fundraisers in the case of a jointly-hosted event) and the campaign access event tracking details. The fundraiser, co-fundraiser, or campaign visualizes the individual contributions made by the prospective donors that attended the event.

What is claimed is:

1. A method for raising donations, the method comprising:
(a) receiving, from a user, a request for raising a donation for a cause;
(b) identifying a prospect based on said request;
(c) identifying a keyword associated with said cause;
(d) collecting user network information associated with said prospect from a user network provider;
(e) collecting third party information associated with said prospect from a third party provider;
(f) determining by a processor of a computer system a relative likelihood of said prospect making a donation to said cause in comparison to another prospect based on said user network information, said third party information, and said keyword associated with said cause; and
(g) outputting said relative likelihood of said prospect making a donation to said cause in comparison to said other prospect.

2. The method of claim 1, wherein said prospect is associated with said user.

3. The method of claim 1, wherein said user network information is associated with said keyword.

4. The method of claim 1, wherein said third party information is associated with said keyword.

5. The method of claim 1, wherein said determining said relative likelihood of said prospect making a donation to said cause in comparison to said other prospect comprises weighting said user network information and said third party information with a probabilistic model.

6. The method of claim 1, wherein said determining said relative likelihood of said prospect making a donation to said cause in comparison to said other prospect comprises correlating said user network information and said third party information.

7. The method of claim 1, wherein said outputting said relative likelihood of said prospect making a donation to said cause in comparison to said other prospect comprises ranking said prospect against a population of other prospects.

8. The method of claim 1, further comprising scoring said prospect based on said relative likelihood of said prospect making a donation to said cause in comparison to said other prospect.

9. The method of claim 1, further comprising generating by said computer system a customized electronic message for said prospect based on said outputting.

10. The method of claim 9, wherein said customized electronic message is based on a template from said user.

11. The method of claim 1, further comprising generating an additional keyword based on said keyword associated with said cause.

12. The method of claim 1, further comprising generating an additional keyword based on said keyword associated with said cause by accessing user network information associated with said prospect, identifying a topic associated with said prospect, and creating said additional keyword based on said topic.

13. The method of claim 1, wherein said determining said relative likelihood of said prospect making a donation to said cause in comparison to said other prospect comprises weighting said keyword associated with said cause by a keyword attribute.

14. The method of claim 1, wherein said cause is political.

15. The method of claim 1, wherein said cause is non-profit.

16. The method of claim 1, wherein said cause is academic.

17. A computer program product comprising a computer-readable medium having computer-executable code encoded therein, said computer-executable code adapted to be executed to implement a method for raising donations, said method comprising:
a) providing a system, said system comprising:
i) a user input module;
ii) a prospect module;
iii) a keyword module;
iv) an information module;
v) a comparison module; and
vi) an output module;
b) receiving by said user input module a request for raising a donation for a cause;
c) identifying by said prospect module a prospect based on said request;
d) determining by said keyword module a keyword associated with said cause;
e) obtaining by said information module user network information associated with said prospect from a user network provider;
f) obtaining by said information module third party information associated with said prospect from a third party provider;
g) determining by said comparison module a relative likelihood of said prospect making a donation to said cause in comparison to another prospect based on said user network information, said third party information, and said keyword associated with said cause; and
h) outputting by said output module said relative likelihood of said prospect making a donation to said cause in comparison to said other prospect.

18. The computer program product of claim 17, wherein said system further comprises a prospect database, wherein said identifying by said prospect module a prospect based on said request comprises searching said prospect database by said prospect module based on said request, thereby identifying said prospect.

19. The computer program product of claim 17, wherein said system further comprises a ranking module, wherein said method for raising donations further comprises ranking by said ranking module said prospect against a population of other prospects based on said relative likelihood of said prospect making a donation to said cause.

20. The computer program product of claim 17, wherein said system further comprises a scoring module, wherein said method for raising donations further comprises scoring by said scoring module said prospect based on said relative likelihood of said prospect making a donation to said cause.
